(19) United States
(12) Patent Application Publication
(10) Pub. No.: US 2012/0307041 A1
(43) Pub. Date: Dec. 6, 2012

(54) IMAGE ACQUISITION APPARATUS, PATTERN INSPECTION APPARATUS, AND IMAGE ACQUISITION METHOD

(76) Inventors: Nariaki FUJIWARA, Kyoto (JP); Tadashi FUKAO, Kyoto (JP)

(21) Appl. No.: 13/481,392

(22) Filed: May 25, 2012

(30) Foreign Application Priority Data
Jun. 1, 2011 (JP) 2011-123071
Sep. 21, 2011 (JP) 2011-205886
Sep. 29, 2011 (JP) 2011-213759

(51) Int. Cl. H04N 5/253

(52) U.S. Cl. 348/96; 348/E05.049

(57) ABSTRACT

An image acquisition part of an apparatus includes a light irradiation part, a line sensor, an angle change mechanism, and a conveying mechanism for conveying a web. The light irradiation part emits light of a wavelength having the property of passing through a thin film pattern of the web. An irradiation angle of the light from the light irradiation part and a detection angle at which the line sensor captures an image are always the same, and these angles are changed by the angle change mechanism. In the apparatus, a set angle at which the contrast in an image is increased is obtained in advance for the irradiation angle and the detection angle, and these angles are set to that set angle. This enables the line sensor to acquire a high-contrast image using a light source having a single wavelength, thus reducing the manufacturing cost of the apparatus.

### TECHNICAL FIELD

The present invention relates to a technique for acquiring an image of a thin film pattern formed on a base material.

### BACKGROUND ART

Inspections of patterns formed on film- or plate-like base materials have conventionally been performed in various fields. For example, the pattern inspection device disclosed in Japanese Patent Application Laid-Open No. 2006-112845 performs inspection of a wiring pattern formed on a resin film. With the pattern inspection device, a good-contrast image can be obtained using a light emitting diode (LED) that emits only light with a wavelength of 500 nm or above, as a light source.

In the film thickness measuring apparatus disclosed in Japanese Patent Application Laid-Open No. 2004-101505, a transparent polyester film is irradiated with light from a semiconductor laser, and the intensity of regularly reflected light is detected by a silicon photodiode. The semiconductor laser and the silicon photodiode are moved in the range of 0° to 90° by a stepping motor, as a result of which the angle of incidence of the light is changed.

Incidentally, flat panel displays (FPDs) have been provided in various electronic devices in recent years. In the manufacture of such display devices, when inspection of the external appearance of a transparent pattern such as a transparent electrode is carried out, an image of the pattern is acquired by irradiating a glass substrate with light and receiving reflected light, for example. The acquired image is processed and then compared with a reference image, by which the presence or absence of defects in the pattern is determined.

Inspection apparatuses use a lamp, an LED, a laser diode (LD) or the like as their light sources, and a difference in brightness, i.e., contrast, between a pattern and a background is produced by optical interference by an object to be inspected. When acquiring an image of a pattern using optical interference, the wavelength at which a good-contrast image can be acquired varies due to the influence of the pattern, the thickness of a thin film existing on the pattern, an optical constant, and the like. Accordingly, as a light source, provided are a lamp and a mechanism for switching between a plurality of interference filters, or provided are a plurality of LEDs to emit light of a plurality of wavelengths. In the case where such a method is employed, the scale of the light sources becomes large and the manufacturing cost of the inspection apparatuses increases.

Furthermore, in the case of using light of a plurality of wavelengths, it is necessary for an optical system to achieve achromatism or aberration correction at multiple wavelengths. This increases the degree of difficulty in designing and manufacturing the optical system, requires an increased amount of light, or increases the manufacturing cost of the optical system. In addition, for example, if a light-sensitive resist is included in an object to be inspected, light having a short wavelength range cannot be emitted, and there are cases where light of an ideal wavelength cannot be used for pattern inspection. The same problem as above also arises when observing (displaying) the external appearance of a transparent pattern.

### SUMMARY OF INVENTION

The present invention is intended for an image acquisition apparatus for acquiring an image of a thin film pattern formed on a base material, and it is an object of the present invention to make it possible to acquire high-contrast images at low cost.

The image acquisition apparatus according to the present invention includes a light irradiation part that emits light of a wavelength having a property of passing through the thin film pattern, a line sensor that receives reflected light from a line-shaped image capturing region irradiated with the light, a moving mechanism for moving the base material relative to the image capturing region in a direction intersecting the image capturing region, and an angle change mechanism for changing an irradiation angle and a detection angle while keeping the irradiation angle and the detection angle equal to each other, the irradiation angle being an angle formed by an optical axis from the light irradiation part to the image capturing region and a normal line of the base material, and the detection angle being an angle formed by the normal line and an optical axis from the image capturing region to the line sensor. The present invention makes it possible to acquire high-contrast images at low cost.

In a preferred embodiment of the present invention, the image acquisition apparatus acquires an inspection image to be used for inspection of a thin film pattern.

In another preferred embodiment of the present invention, the image acquisition apparatus further includes a display part that displays the image of the thin film pattern based on output from the line sensor. This makes it possible to display high-contrast images at low cost.

In yet another preferred embodiment of the present invention, the image acquisition apparatus further includes a control part. The line sensor is provided in a light receiving part. The light receiving part further includes an optical system that guides the reflected light from the image capturing region to the line sensor. The angle change mechanism includes a detection-angle change mechanism for changing the detection angle that is an angle formed by an optical axis of the optical system and the normal line of the base material, and a light receiving part-moving mechanism for moving the light receiving part along the optical axis of the optical system. The light irradiation part, the light receiving part, and the angle change mechanism are provided in an imaging unit that captures an image of the image capturing region. The control part causes a conjugate position of the optical axis of the optical system that has a conjugate relationship with a light receiving surface of the line sensor, to be disposed on the thin film pattern by controlling the light receiving part-moving mechanism based on an amount of change in the detection angle. This makes it possible to easily perform focus adjustment of the light receiving part while changing the detection angle.

The present invention is also intended for a pattern inspection apparatus for inspecting a thin film pattern formed on a base material and is further intended for an image acquisition method for acquiring an image of a thin film pattern formed on a base material.

These and other objects, features, aspects and advantages of the present invention will become more apparent from the following detailed description of the present invention when taken in conjunction with the accompanying drawings.

### BRIEF DESCRIPTION OF DRAWINGS

FIG. 1 is a diagram showing a schematic configuration of a pattern inspection apparatus according to a first embodiment;

FIG. 2 is a front view of an image acquisition part;

FIG. 3 is a plan view of the image acquisition part;

FIG. 4 is a rear view of the image acquisition part;

FIG. 5 is a block diagram showing a functional configuration of the pattern inspection apparatus;

FIG. 6 is a flowchart of operations performed by the pattern inspection apparatus;

FIGS. 7 and 8 are diagrams showing examples of profiles;

FIG. 9 is a front view showing another example of the image acquisition part;

FIGS. 10A to 10C and FIGS. 11A to 11D are diagrams showing examples of profiles;

FIG. 12 is a diagram showing part of a functional configuration of a pattern inspection apparatus according to a second embodiment;

FIG. 13 is a flowchart of part of operations performed by the pattern inspection apparatus;

FIG. 14 is a diagram showing a pattern inspection apparatus according to a third embodiment;

FIG. 15 is a diagram showing a schematic configuration of a pattern-image display apparatus according to a fourth embodiment;

FIG. 16 is a front view of an image acquisition part;

FIG. 17 is a plan view of the image acquisition part;

FIG. 18 is a rear view of the image acquisition part;

FIG. 19 is a block diagram showing a functional configuration of the pattern-image display apparatus;

FIG. 20 is a flowchart of operations performed by the pattern-image display apparatus;

FIG. 21 is a diagram showing examples of profiles;

FIG. 22 is a diagram showing a plurality of rectangular regions on a glass substrate;

FIG. 23 is a front view showing another example of the image acquisition part;

FIG. 24 is a diagram showing part of a functional configuration of a pattern-image display apparatus according to a fifth embodiment;

FIG. 25 is a flowchart of part of operations performed by the pattern-image display apparatus;

FIG. 26 is a diagram showing a pattern-image display apparatus according to a sixth embodiment;

FIG. 27 is a diagram showing another example of the image acquisition part;

FIG. 28 is a diagram showing a schematic configuration of an image acquisition apparatus according to a seventh embodiment;

FIG. 29 is a side view of an imaging unit;

FIG. 30 is a rear view of a light irradiation part-turning mechanism;

FIG. 31 is a diagram showing the imaging unit;

FIG. 32 is a block diagram showing a functional configuration of the image acquisition apparatus;

FIG. 33 is a flowchart of operations performed by the image acquisition apparatus;

FIG. 34 is a diagram showing examples of profiles;

FIG. 35 is a flowchart of operations relating to angle adjustment;

FIGS. 36 to 38 are diagrams illustrating the operations relating to angle adjustment;

FIG. 39 is a diagram showing another example of the image acquisition apparatus;

FIG. 40 is a diagram showing another example of the light irradiation part; and

FIGS. 41 to 43 are diagrams each showing yet another example of the image acquisition apparatus.

### DESCRIPTION OF EMBODIMENTS

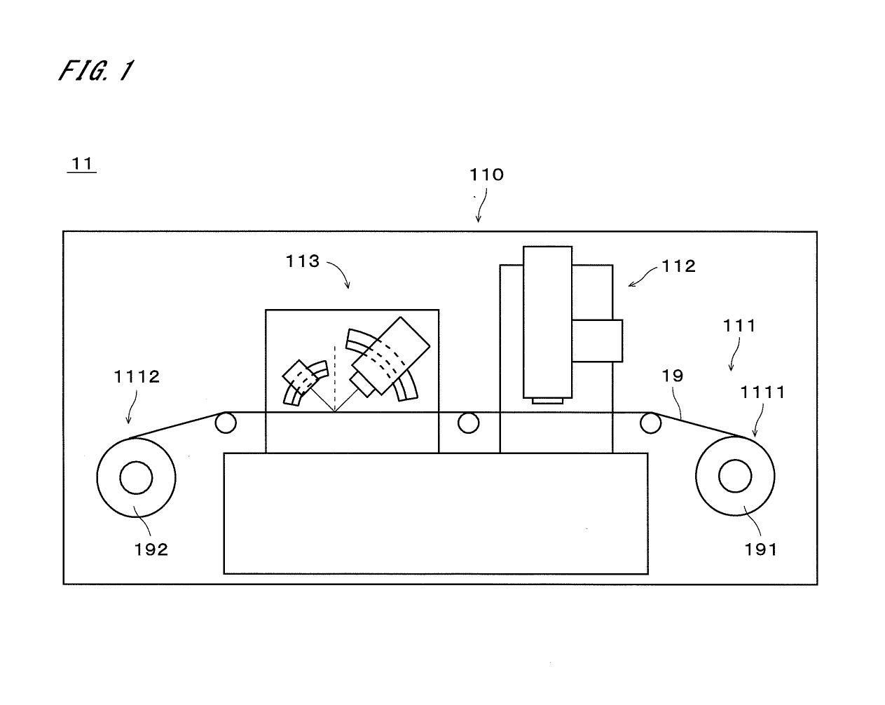

FIG. 1 is a front view showing a schematic configuration of a pattern inspection apparatus 11 according to a first embodiment of the present invention. The pattern inspection apparatus 11 acquires an inspection image that is an image of a multilayer thin film pattern formed on a base material, and executes inspection of the thin film pattern based on the inspection image. In FIG. 1, the base material is a web of resin film, that is, a continuous sheet. The thin film pattern is, for example, a transparent electrode film, and in the present embodiment, the base material and the thin film pattern are covered with a transparent film. In actuality, other layers such as an antireflection film are also formed on the base material. In the following description, the thin film pattern is simply referred to as a “pattern”. The base material and the film on the base material are collectively referred to as a “web 19” or “object to be inspected”. The web 19 is used in the manufacture of a capacitance-operated touch panel.

The pattern inspection apparatus 11 includes a conveying mechanism 111 for conveying the web 19, a film thickness measurement part 112, and an image acquisition part 113. The pattern inspection apparatus 11 further includes, for example, an overall control part and an inspection part, which will be described later. The conveying mechanism 111, the film thickness measurement part 112, and the image acquisition part 113 correspond to an inspection-image acquisition apparatus 110 included in the pattern inspection apparatus 11. The conveying mechanism 111 includes a supply part 1111 located on the right side in FIG. 1 and a collection part 1112 located on the left side. The supply part 1111 supports the pre-inspection web 19 in the form of a roll 191 and feeds out the web 19 in the leftward direction. The collection part 1112 supports the post-inspection web 19 in the form of a roll 192 and collects the web 19.

The film thickness measurement part 112 and the image acquisition part 113 are disposed in the order specified from the supply part 1111 side toward the collection part 1112. The film thickness measurement part 112 is a spectral film thickness gauge of an optical interference type that irradiates the web 19 with measurement light and acquires the spectrum of reflected light. The film thickness of each layer is obtained by, based on the assumption of a pre-set film structure, changing the mathematical film thickness of each layer and fitting the (optical) spectrum obtained by calculation to the spectrum acquired by measurement.

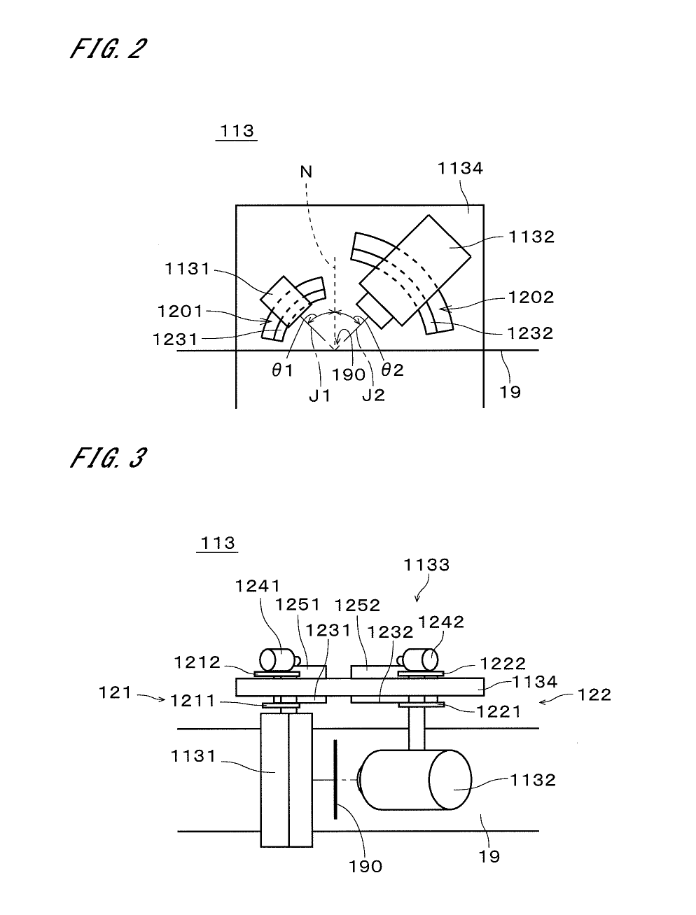

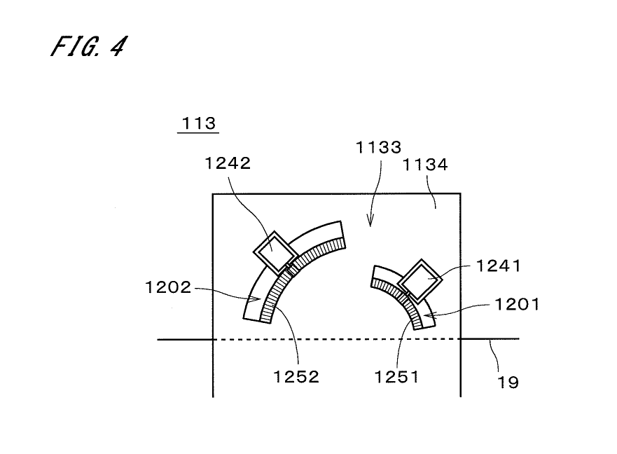

FIG. 2 is a front view of the image acquisition part 113, FIG. 3 is a plan view thereof, and FIG. 4 is a rear view thereof. The image acquisition part 113 includes a light irradiation part 1131 that emits light to an image capturing region 190 on the web 19, a line sensor 1132 that receives reflected light from the image capturing region 190, and an angle change mechanism 1133 for changing a light irradiation angle of the light irradiation part 1131 and a detection angle of the line sensor 1132. It may be assumed that the image acquisition part 113 includes part of the conveying mechanism 111. Here, the irradiation angle is an angle θ1 formed by an optical axis J1 from the light irradiation part 1131 to the image capturing region 190 and a normal line N of the web 19. The detection angle is an angle θ2 formed by an optical axis J2 from the image capturing region 190 to the line sensor 1132 and the normal line N.

The light irradiation part 1131 emits light of a wavelength having the property of passing through a pattern. At least the line-shaped image capturing region 190 is irradiated with the light. The light irradiation part 1131 includes a plurality of LEDs arranged in a direction that is perpendicular to a conveyance direction of the web 19 and the vertical direction, and an optical system that homogenizes light from the LEDs and guides the homogenized light to the image capturing region 190. The line sensor 1132 includes a one-dimensional image sensor and an optical system that establishes an optically conjugate relationship between the image capturing region 190 and a light receiving surface of the image sensor. The web 19 is conveyed in a direction intersecting the image capturing region 190 by the conveying mechanism 111. Specifically, the conveying mechanism 111 is a moving mechanism for moving the base material of the web 19 relative to the image capturing region 190. While in the present embodiment, the web 19 is conveyed in the direction that is perpendicular to the image capturing region 190, the image capturing region 190 may be inclined with respect to the conveyance direction.

Note that in the following description, the base material and the pattern are distinguished from each other as necessary, but in the description about handling or the like of the object to be inspected (web 19), the base material and the object to be inspected are not strictly distinguished from each other because most part of the object to be inspected is made up of the base material.

The angle change mechanism 1133 changes the irradiation angle θ1 and the detection angle θ2 while keeping the irradiation angle θ1 and the detection angle θ2 equal to each other. Thus, in the following description, the magnitude of the detection angle is equal to that of the irradiation angle, and the magnitude of the irradiation angle is equal to that of the detection angle. The light irradiation part 1131 and the line sensor 1132 are supported by a base wall 1134 via the angle change mechanism 1133. The base wall 1134 is a plate member that is parallel to the conveyance direction and the vertical direction.

The base wall 1134 is provided with a first opening 1201 and a second opening 1202 both having the shape of an arc centered on the image capturing region 190. A first support part 121 that supports the light irradiation part 1131 is inserted in the first opening 1201. A second support part 122 that supports the line sensor 1132 is inserted in the second opening 1202. The first support part 121 and the second support part 122 are part of the angle change mechanism 1133. The angle change mechanism 1133 further includes a first guide part 1231, a first motor 1241, and a first rack 1251, which are for moving the light irradiation part 1131, and a second guide part 1232, a second motor 1242, and a second rack 1252, which are for moving the line sensor 1132.

The first guide part 1231 is provided along the first opening 1201 on the light irradiation part 1131 side of the base wall 1134 and guides movement of the light irradiation part 1131 in a circumferential direction around the image capturing region 190. A mobile unit 1211 of the first support part 121 moves along the first guide part 1231. The first support part 121 further includes a support plate 1212 on the side of the base wall 1134 opposite the light irradiation part 1131, and the first motor 1241 is supported by the support plate 1212. The first rack 1251 is provided along the first opening 1201 on the side of the base wall 1134 opposite the light irradiation part 1131. The first rack 1251 meshes with a pinion gear provided at an output shaft of the first motor 1241 and gives driving force to the first support part 121, thereby moving the light irradiation part 1131.

A mechanism for moving the line sensor 1132 is similar to that for moving the light irradiation part 1131. Specifically, the second guide part 1232 is provided along the second opening 1202 on the line sensor 1132 side of the base wall 1134 and guides movement of the line sensor 1132 in a circumferential direction around the image capturing region 190. A mobile unit 1221 of the second support part 122 moves along the second guide part 1232. The second support part 122 further includes a support plate 1222 on the side of the base wall 1134 opposite the line sensor 1132, and the second motor 1242 is supported by the support plate 1222. The second rack 1252 is provided along the second opening 1202 on the side of the base wall 1134 opposite the line sensor 1132. The second rack 1252 meshes with a pinion gear provided at an output shaft of the second motor 1242 and gives driving force to the second support part 122, thereby moving the line sensor 1132.

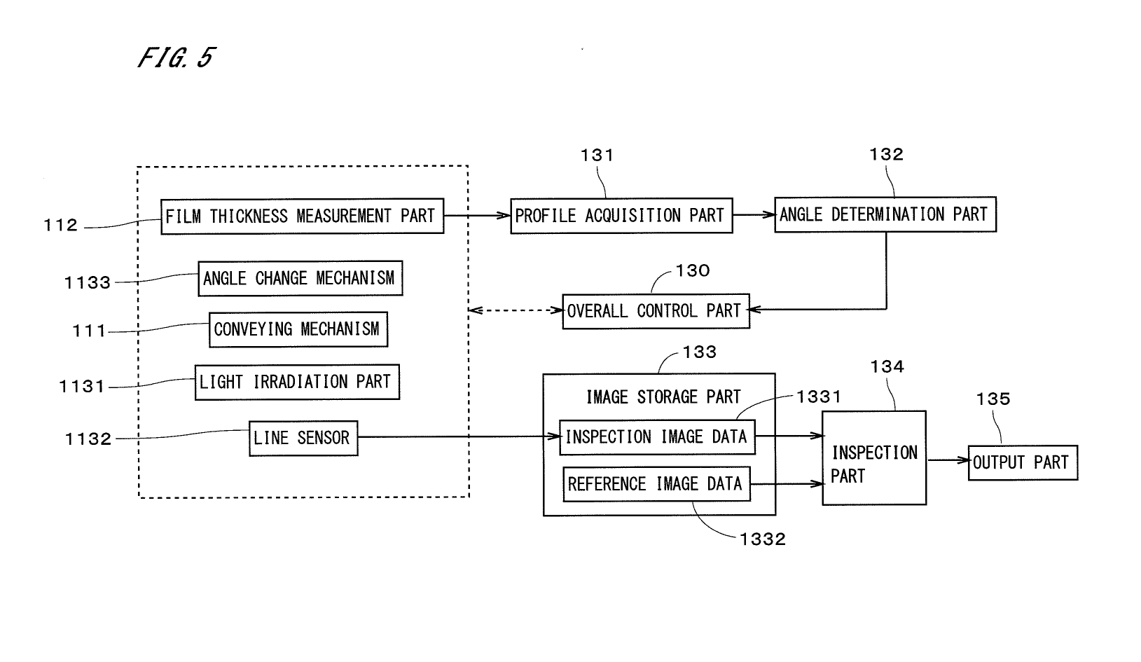

FIG. 5 is a block diagram showing a functional configuration of the pattern inspection apparatus 11. The configuration enclosed by the dashed line corresponds to the configuration shown in FIG. 1. The pattern inspection apparatus 11 includes a profile acquisition part 131 that receives output from the film thickness measurement part 112, an angle determination part 132 that receives a later-described profile obtained by the profile acquisition part 131, an overall control part 130 that performs overall control, an image storage part 133 that receives output from the line sensor 1132, an inspection part 134, and an output part 135 that outputs an inspection result to an operator or other devices. The profile acquisition part 131, the angle determination part 132, the image storage part 133, and the overall control part 130 are part of the inspection-image acquisition apparatus 110.

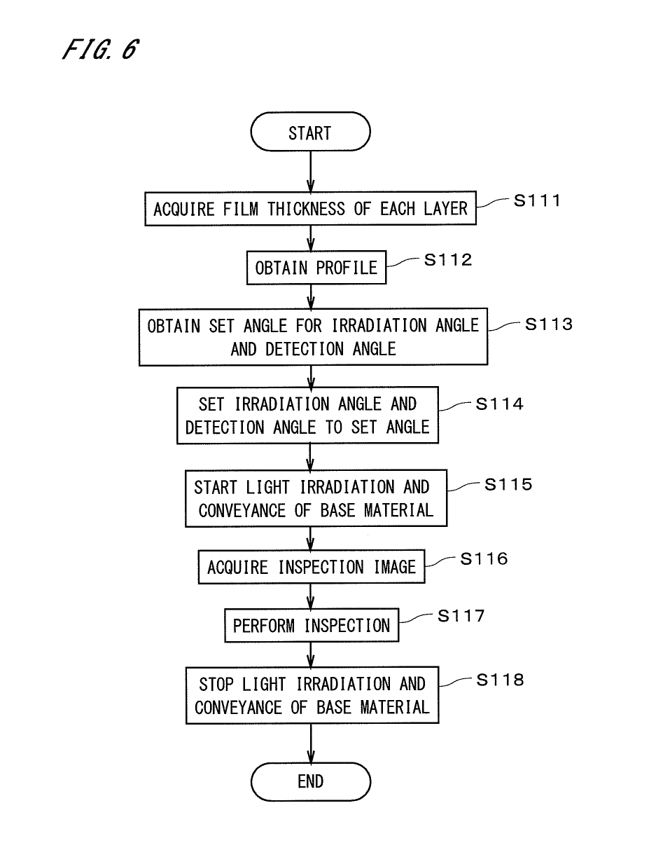

FIG. 6 is a flowchart of operations performed by the pattern inspection apparatus 11. In the pattern inspection apparatus 11, first the conveying mechanism 111 is controlled such that a region of the web 19 in which a pattern is present is disposed under the film thickness measurement part 112, and the film thickness measurement part 112 acquires the film thickness of each layer. By further controlling the conveying mechanism 111, a background region that is a region around the pattern is disposed under the film thickness measurement part 112, and the film thickness of each layer in the background region is also acquired (step S111). Note that a configuration is also possible in which the thickness of each layer in only a region where a pattern is present is acquired, and the film thickness of each layer in the background is estimated based on the acquired film thicknesses.

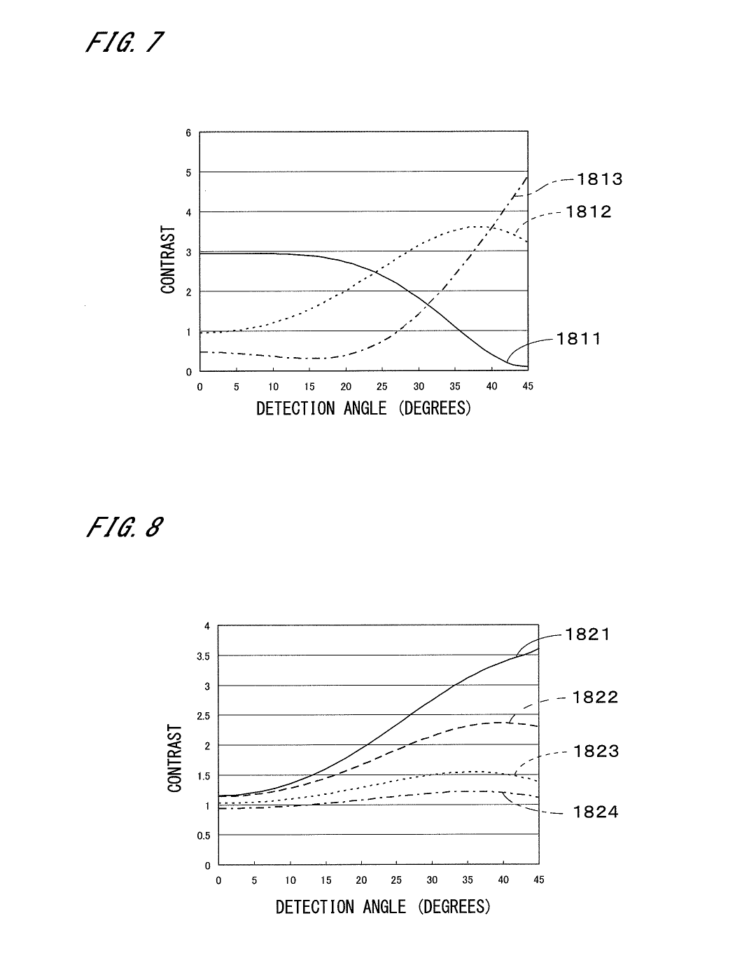

The results of the measurement of the film thicknesses are input to the profile acquisition part 131. In the profile acquisition part 131, a profile indicating the relationship between the (irradiation angle and) detection angle and the contrast is obtained by calculation based on the layer structure on the base material and the film thickness of each layer (step S112). FIG. 7 is a diagram illustrating acquired profiles. A solid line 1811 indicates the relationship between the detection angle and the contrast in the case where a 900 nm-thick transparent film has been formed on a 30 nm-thick transparent electrode pattern. It is assumed that there is only the 900 nm-thick transparent film in the background. The irradiation light has a wavelength of 570 nm.

Here, the contrast refers to the ratio between the intensity of light incident upon the line sensor 1132 in the case where a multilayer film including a pattern is present on the base material and the intensity of light incident upon the line sensor 1132 in the case where the above multilayer film but that does not include the pattern is present on the base material. In other words, the contrast is the ratio in brightness between the pattern and the background (=(brightness in pattern region)/(brightness in background region)). The brightness corresponds to reflectance at that wavelength, and thus the ratio in brightness is also the ratio in reflectance. Of course, other values such as a difference in brightness or reflectance may be used as the contrast.

In FIG. 7, favorable pattern inspection is normally possible if the contrast is 0.5 or less or 2 or more. In the case of the solid line 1811, an appropriate inspection image can be obtained if the detection angle is approximately in the range of 0° to 28° or in the range of 40° to 45°. It is, however, to be noted that the upper-limit angle of 45° in FIG. 7 is merely one example. Note that if the contrast is 0.77 or less or 1.3 or more, it is possible to perform inspection depending on conditions. However, the contrast is preferably 0.67 or less or 1.5 or more. Furthermore, “high contrast” refers to “good contrast” and means a state in which brightness and darkness are clearly distinguishable. “High contrast” does not necessarily mean that the value of the contrast is high.

A dashed line 1812 in FIG. 7 indicates the relationship between the detection angle and the contrast in the case where a 960 nm-thick transparent film has been formed on a 30 nm-thick transparent electrode pattern. It is assumed that there is only the 960 nm-thick transparent film in the background. A dashed dotted line 1813 indicates the relationship between the detection angle and the contrast in the case where a 1000 nm-thick transparent film has been formed on a 30 nm-thick transparent electrode pattern. It is assumed that there is only the 1000 nm-thick transparent film in the background. The irradiation light has a wavelength of 570 nm. As indicated by the curves 1811 to 1813, it is clear that the detection angle at which a high-contrast inspection image is obtained varies greatly with a change in the thickness of the transparent film.

Specifically, changing the detection angle changes the optical path length of light passing through each transparent layer and changes a state of interference of the light. As a result, even in the case where a high contrast cannot be obtained at a specific detection angle, it is possible to obtain a high contrast by changing the detection angle without changing the wavelength. In other words, inspection that is equivalent to pattern inspection involving selecting a wavelength from among a large number of wavelengths with use of a white light source and a large number of filters can be realized by changing the detection angle.

In the angle determination part 132, an angle that is to be set for the irradiation angle and the detection angle (hereinafter referred to as a “set angle”) is determined based on the acquired profile (step S113). When determining the set angle, the movable ranges of the light irradiation part 1131 and the line sensor 1132 and other inspection conditions are taken into consideration. The set angle is input to the overall control part 130, and the irradiation angle and the detection angle are set to the set angle by the overall control part 130 controlling the angle change mechanism 1133 (step S114).

When the above-described preparation operation has been completed, light emission from the light irradiation part 1131 is started, and conveyance of the web 19 by the conveying mechanism 111 is started (step S115). The line sensor 1132 repeatedly acquires a line image of the line-shaped image capturing region 190 at high speed. As a result, inspection image data 1331 that is two-dimensional image data indicating the pattern is stored in the image storage part 133 (step S116).

Meanwhile, reference image data 1332 to be used as a reference is also stored in the image storage part 133. The inspection image data 1331 and the reference image data 1332 are sent to the inspection part 134, and the inspection part 134 determines the presence or absence of defects by comparing the inspection image data 1331 and the reference image data 1332 (step S117). Steps S116 and S117 are repeatedly executed every time the web 19 has been conveyed a fixed distance, and when all the inspection of the web 19 has been completed, the light irradiation and the conveyance of the web 19 are stopped, and the inspection ends (step S118).

As described above, the pattern inspection apparatus 11 can acquire an inspection image that has a high contrast between the pattern and the background, without changing the wavelength of the light used to irradiate the image capturing region 190. This eliminates the need to provide a complicated configuration for changing the wavelength, to design an optical system in conformity with light of multiple wavelengths, or to make complex adjustment, thus making it possible to reduce the manufacturing costs of the inspection-image acquisition apparatus 110 and the pattern inspection apparatus 11. Furthermore, for example, even if a light-sensitive resist is included in a layer on the pattern, pattern inspection can be easily performed while avoiding light of a wavelength that cannot be used.

Moreover, because the profile acquisition part 131 acquires a profile, the angle determination part 132 can easily determine the most preferable angle. Using the film thickness measurement part 112 makes it possible to acquire a profile promptly, thus increasing the efficiency of inspection.

FIG. 8 is a diagram illustrating profiles in the case where the pattern has a small film thickness. A solid line 1821 indicates a profile in the case where a 650 nm-thick transparent film has been formed on a 30 nm-thick transparent electrode film. A long dashed line 1822, a short dashed line 1823, and a dashed dotted line 1824 indicate profiles in the case where the thickness of the transparent electrode film is changed to 20 nm, 10 nm, and 5 nm, respectively, and the transparent film has a thickness of 650 nm. It is assumed that there is only the 650 nm-thick transparent film in the background. The same applies to the following similar drawings.

As shown in FIG. 8, in practice, the pattern preferably has a thickness of 10 nm or more. In the case where the pattern is foamed from a transparent electrode, the thickness of the pattern is usually 100 nm or less. Even in the case where a transparent pattern is formed from a different type of film, the thickness of the pattern is usually 2000 nm or less. Note that various materials are applicable to the pattern, and for example, the pattern may be formed from a thin chromium film. The content of the above description based on FIG. 8 also applies to other embodiments.

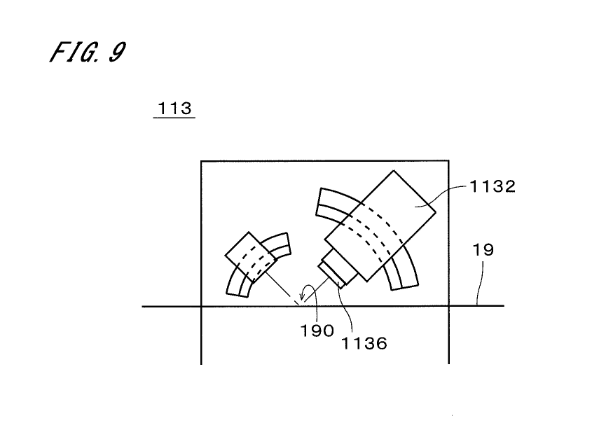

FIG. 9 is a front view showing another example of the image acquisition part 113. In the image acquisition part 113 shown in FIG. 9, a polarizer 1136 is disposed between the image capturing region 190 and the line sensor 1132. As a result, only p-polarized light out of the reflected light from the web 19 is incident on the line sensor 1132. The other configurations of the pattern inspection apparatus 11 are the same as in FIG. 1.

In the pattern inspection apparatus 11 including the image acquisition part 113 of FIG. 9, a profile regarding the p-polarized light is acquired by the profile acquisition part 131. Specifically, the change of the contrast depending on the detection angle, the contrast being the ratio between the intensity of the p-polarized light from a region in which the pattern is formed and the intensity of the p-polarized light from the background, is acquired as the profile.

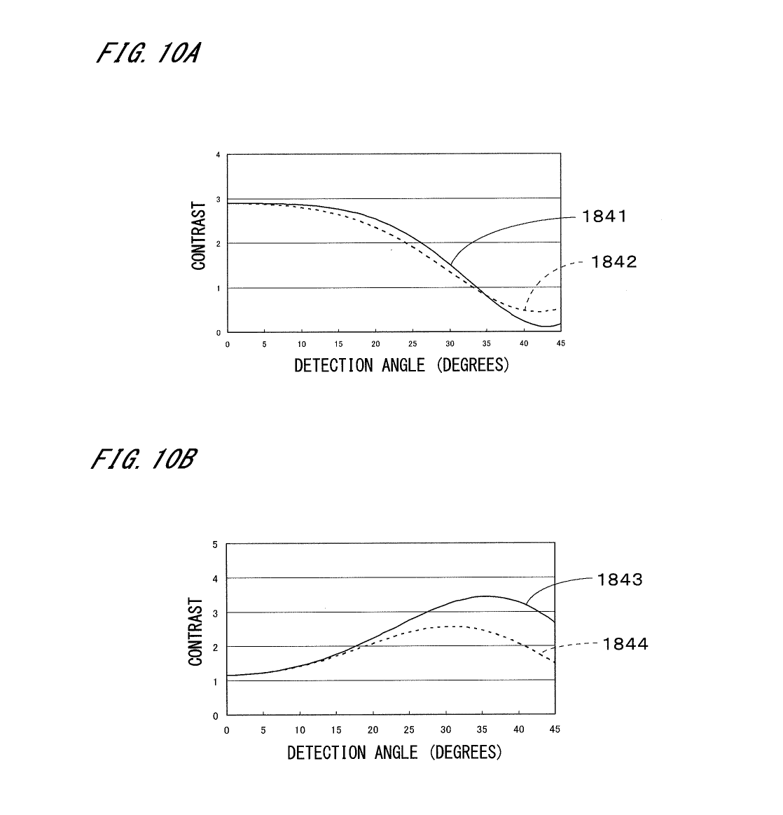

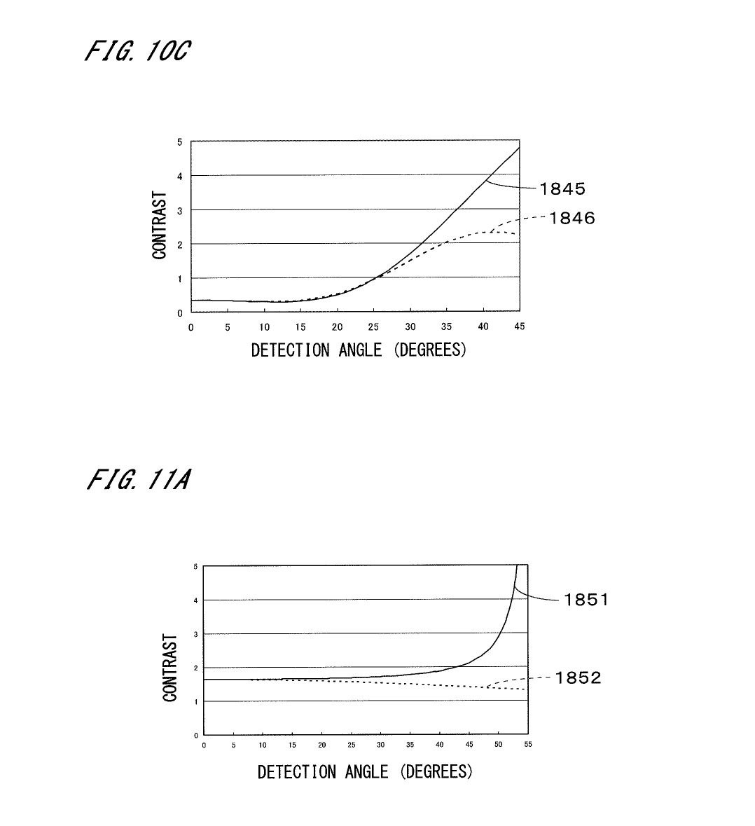

FIGS. 10A, 10B, and 10C show profiles in the cases where 900 nm-, 960 nm-, and 1000 nm-thick transparent films have been formed respectively on a 30 nm-thick transparent electrode pattern. The light has a wavelength of 570 nm. Solid lines 1841, 1843, and 1845 indicate profiles regarding the p-polarized light, and dashed lines 1842, 1844, and 1846 indicate profiles regarding s-polarized light. It is clear from these profiles that in the film structures shown in FIGS. 10B and 10C, a higher-contrast inspection image can be acquired by using the p-polarized light as compared with the case of not using the polarized light. Furthermore, it is also clear that a preferable detection angle greatly varies depending on the thickness of the transparent film.

In the pattern inspection apparatus 11, the irradiation angle and the detection angle are determined based on the profile regarding the p-polarized light. Then, a high-contrast image is acquired by the line sensor 1132 receiving the p-polarized light. This improves the accuracy of pattern inspection. Note that if a higher-contrast inspection image can be obtained by receiving the s-polarized light rather than receiving the p-polarized light, the line sensor 1132 is provided with another polarizer 1136 for receiving the s-polarized light. Using the polarized light is particularly suitable for the case where the pattern is extremely thin.

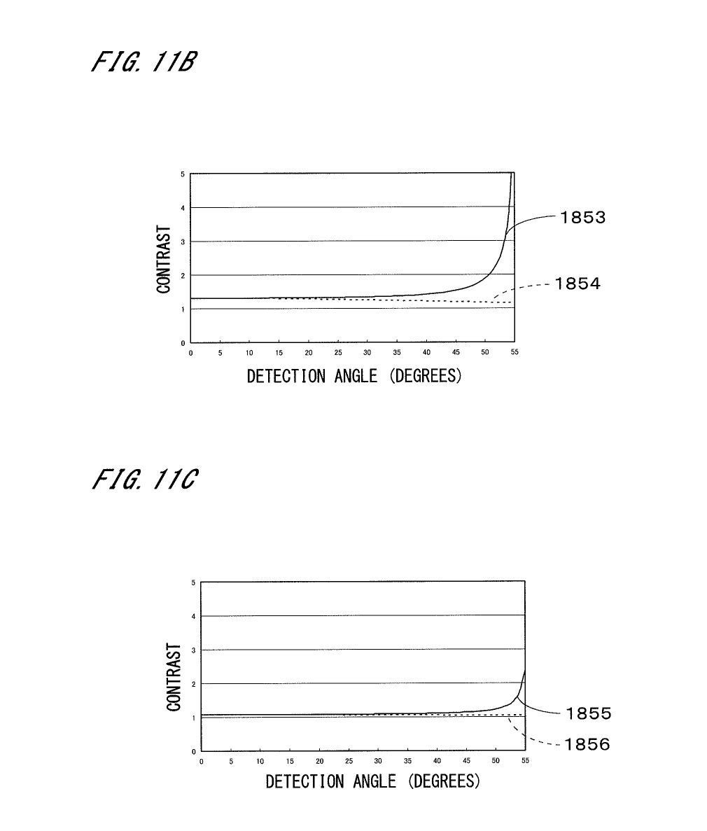

FIGS. 11A, 11B, 11C, and 11D show profiles obtained with 30 nm-, 20 nm-, 10 nm-, and 5 nm-thick transparent electrode patterns, respectively. The light has a wavelength of 570 nm. Solid lines 1851, 1853, 1855, and 1857 indicate profiles regarding the p-polarized light, and dashed lines 1852, 1854, 1856, and 1858 indicate profiles regarding the s-polarized light. It is also clear from these profiles that using the p-polarized light makes it possible to acquire a higher-contrast inspection image than in the case of not using the polarized light. Furthermore, it is clear that, in practice, inspection using the contrast is possible if the pattern has a film thickness of 10 nm or more. In general, in the case where the pattern is thin, a high contrast can be obtained by increasing the detection angle. The content of the above description based on FIGS. 10A to 10C and FIGS. 11A to 11D also applies to other embodiments.

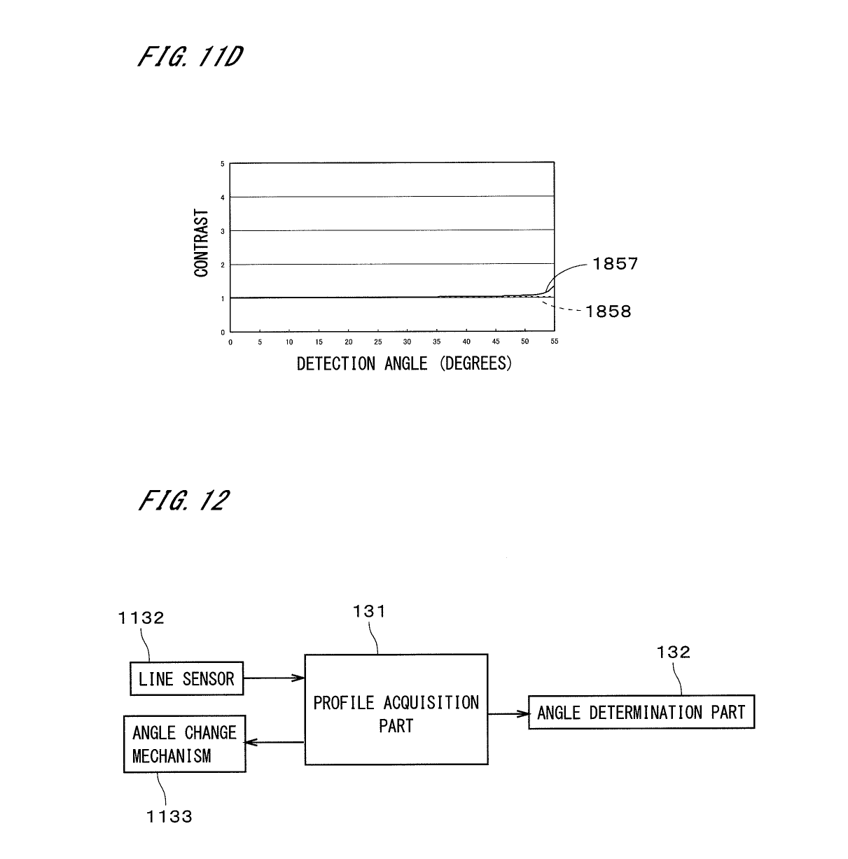

FIG. 12 is a diagram showing a functional configuration around the profile acquisition part 131 of a pattern inspection apparatus 11 according to a second embodiment. In the second embodiment, the film thickness measurement part 112 is omitted from the pattern inspection apparatus 11. The other configurations are the same as in the first embodiment, and the same reference numerals have been given to constituent elements that are the same as in the first embodiment.

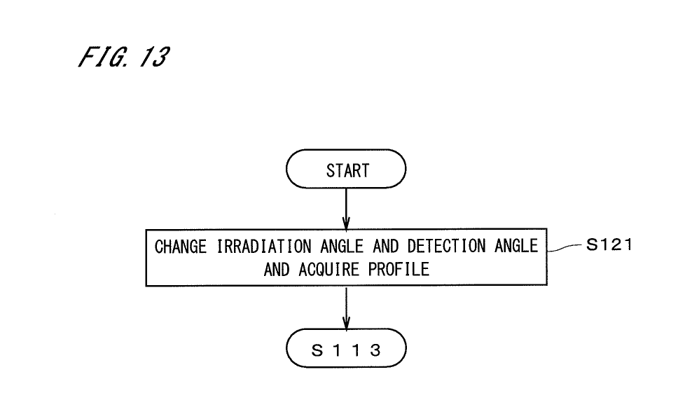

The profile acquisition part 131 controls the angle change mechanism 1133 and receives input of signals from the line sensor 1132. When acquiring a profile, first the conveying mechanism 111 positions the web 19 such that both the pattern and the background are present in the image capturing region 190. Next, the line sensor 1132 repeatedly acquires a line image of the image capturing region 190 while the irradiation angle and the detection angle are changed by the profile acquisition part 131. In the profile acquisition part 131, every time a line image has been acquired by the line sensor 1132, the ratio between the intensity of light from the pattern region and the intensity of light from the background region is obtained as the contrast. The irradiation angle and the detection angle are changed from the smallest to the largest while being kept equal to each other. As a result, a profile indicating the relationship between the detection angle and the contrast is acquired (FIG. 13: step S121).

The acquired profile is sent to the angle determination part 132 in which the set angle is then determined (FIG. 6: step S113). Hereinafter, pattern inspection is executed through the same operations as in the first embodiment.

In the second embodiment as well, an inspection image that has a high contrast between the pattern and the background can be acquired without changing the wavelength of the light used to irradiate the image capturing region 190. This makes it possible to reduce the manufacturing cost of the inspection-image acquisition apparatus 110 and the pattern inspection apparatus 11. Furthermore, because the film thickness measurement part is omitted, the manufacturing cost of the inspection-image acquisition apparatus 110 and the pattern inspection apparatus 11 can be further reduced.

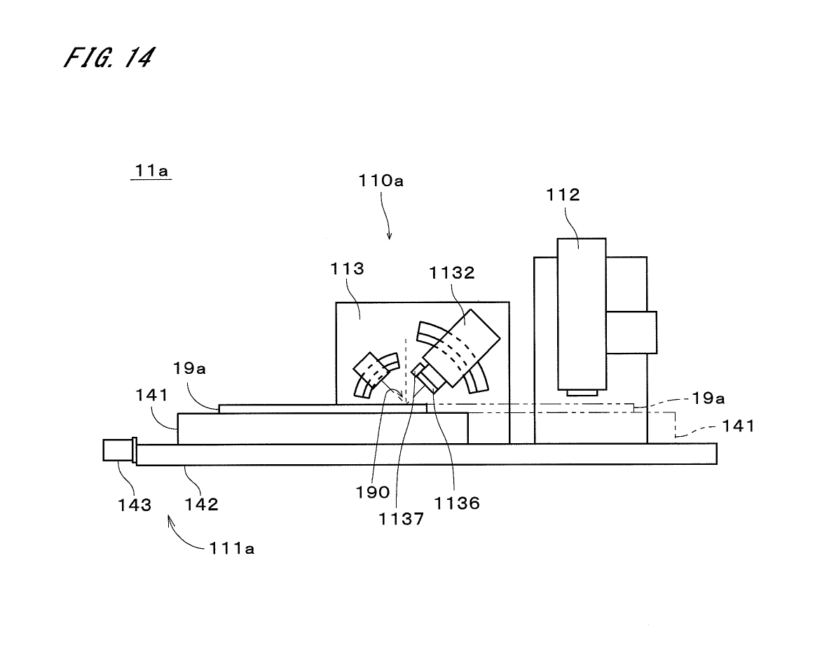

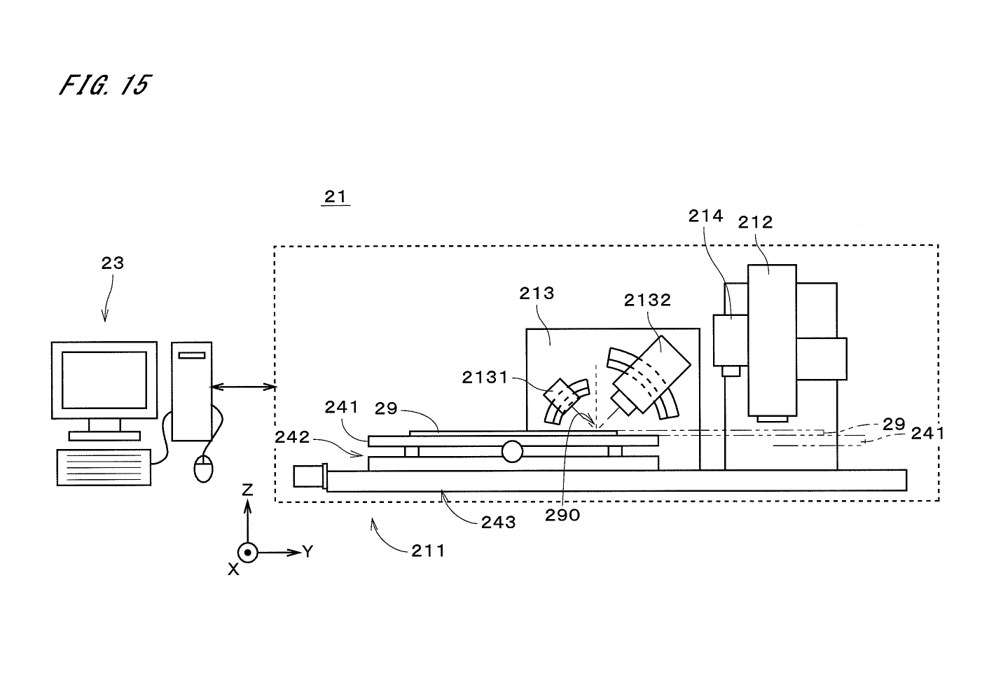

FIG. 14 is a diagram showing an inspection-image acquisition apparatus 110a of a pattern inspection apparatus 11a according to a third embodiment. The other configurations are the same as in FIG. 5.

The pattern inspection apparatus 11a includes a conveying mechanism 111a, a film thickness measurement part 112, and an image acquisition part 113, and has the same configuration as in the first embodiment, with the exception that the configuration of the conveying mechanism 111a and part of the image acquisition part 113 differ from those in FIG. 1. An object to be inspected is a glass substrate 19a on which a transparent electrode film, a transparent film and the like are formed.

The conveying mechanism 111a includes a stage 141 that holds the glass substrate 19a on the upper surface, a guide rail 142 that guides rightward and leftward movement of the stage 141, a motor 143, and a transfer mechanism (not shown) for transferring the driving force of the motor 143. The conveying mechanism 111a is a moving mechanism for moving a base material constituting a main portion of the glass substrate 19a, relative to an image capturing region 190. In the image acquisition part 113, a polarizer 1136 is disposed between the image capturing region 190 and a line sensor 1132, and a rotation mechanism 1137 for rotating the polarizer 1136 about the optical axis is further provided. The rotation mechanism 1137 is a polarization switching mechanism for changing the direction of polarization by the polarizer 1136.

When performing inspection, the glass substrate 19a that is an object to be inspected is held on the stage 141 and disposed under the film thickness measurement part 112 as indicated by the chain double-dashed line. Then, the film thickness of each layer on the base material of the glass substrate 19a is acquired (FIG. 6: step S111). Following this, based on the measurement result from the film thickness measurement part 112, the profile acquisition part 131 acquires, as profiles, a first profile indicating a first contrast obtained with p-polarized light between the pattern and the background, and a second profile indicating a second contrast obtained with s-polarized light between the pattern and the background (step S112).

The angle determination part 132 obtains the product of the first contrast and the second contrast and determines an angle at which the product differs greatly from 1, as the set angle (step S113). This method is suitable for the case where both the first contrast and the second contrast are close to 1, but the product of these contrasts is relatively different from 1.

Note that as long as it is possible to substantially obtain the product of the first contrast and the second contrast, the first profile and the second profile do not necessarily need to be prepared in a strict sense. For example, a value corresponding to the product of the first contrast and the second contrast may be obtained by obtaining the ratio between the product of the brightness of the p-polarized light and the brightness of the s-polarized light in the pattern and the product of the brightness of the p-polarized light and the brightness of the s-polarized light in the background. Accordingly, the profile acquisition part 131 and the angle change mechanism 1133 do not necessarily need to be distinguishable functions in a strict sense.

When the irradiation angle and the detection angle have been set to the set angle (step S114), light irradiation and movement of the stage 141 are started, and the image acquisition part 113 acquires a first inspection image with the p-polarized light. Furthermore, the rotation mechanism 1137 rotates the polarizer 1136, light irradiation and movement of the stage 141 are performed again, and a second inspection image is acquired with the s-polarized light (steps S115 and S116).

In the inspection part 134, the product of each pixel value in the first inspection image and each corresponding pixel value in the second inspection image is obtained, and pattern inspection is executed based on an image that has the obtained products as its pixel values (step S117). Since the pattern inspection apparatus 11a performs inspection using the product of the intensity of the p-polarized light and the intensity of the s-polarized light, appropriate inspection can be realized when a difference in the product between the pattern and the background is large. Also, the reliability of inspection is improved as a result of using two different types of images. In the pattern inspection apparatus 11a as well, a mechanism for switching the wavelength of the light source is unnecessary. Accordingly, it is possible to reduce the manufacturing cost of the inspection-image acquisition apparatus 110a and the pattern inspection apparatus 11a.

In the pattern inspection apparatus 11a, inspection may be performed without the polarizer 1136 as in the first embodiment, or inspection may be performed using only either the p-polarized light or the s-polarized light. Furthermore, a configuration is also possible in which the film thickness measurement part 112 is omitted and the operation shown in FIG. 13 is executed. If the width of the glass substrate 19a is greater than the length of the image capturing region 190, a mechanism for moving the stage 141 in a direction that is perpendicular to the plane of FIG. 14 is additionally provided in the conveying mechanism 111a, and acquisition and inspection of an image are repeatedly performed while moving the glass substrate 19a in the direction perpendicular to the plane of FIG. 14.

While the above has been a description of the first to third embodiments of the present invention, the above-described embodiments can be modified in various ways.

The base material of the object to be inspected is not limited to a film or a glass substrate, and may be formed from other materials such as a resin plate. The film structure formed on the base material may have various configurations as described above, and normally, it has a more complicated configuration than illustrated in the above-described embodiments. A pattern that is an object to be inspected is not limited to a single type, and may be of a plurality of types. In this case, when inspecting the pattern of each object to be inspected, the other patterns overlapping with that pattern are regarded as the background.

While a single type of background has been described in the above embodiments, the background is not limited to a single type. If there are a plurality of types of backgrounds, a profile is obtained for each of the backgrounds, and the irradiation angle and the detection angle at which a high contrast is obtained for all of the backgrounds are determined by the angle determination part 132.

The thin film pattern may be composed of other materials as long as the pattern has a certain degree of transparency to the irradiation light, and the pattern does not necessarily need to be transparent to visible light. The pattern is not limited to a transparent electrode, and may be patterns for other applications. However, the pattern inspection apparatus is particularly suitable for inspection of a transparent electrode on which no shadow is cast even when the electrode is irradiated with visible light.

The moving mechanism for moving the base material relative to the image capturing region may be a mechanism for fixing the base material and moving the image acquisition part 113. The angle change mechanism 1133 may be a mechanism for linking the irradiation angle and the detection angle together, instead of a mechanism for individually changing the irradiation angle and the detection angle. In the angle change mechanism 1133, the irradiation angle and the detection angle do not necessarily need to be changed in a continuous manner, and they may be changed in only several steps, for example. Furthermore, the angle change mechanism 1133 may be configured to change these angles manually. Although in FIG. 14, the rotation mechanism 1137 is provided as the polarization switching mechanism, the polarization switching mechanism may be a mechanism for switching between two polarizers that have different directions of polarization.

The wavelength of the light emitted from the light irradiation part 1131 is not limited to a single wavelength, and light of a plurality of wavelengths may be emitted selectively. The light source may be an LD, instead of an LED. Furthermore, a combination of a lamp, such as a halogen lamp, and filters may be provided as the light source. The film thickness measurement part 112 may be a spectral ellipsometer.

If the film structure and the film thickness of each layer of the object to be inspected are known, these pieces of information may be directly input to the profile acquisition part 131 by an operator, and the film thickness measurement part 112 may be omitted. Furthermore, a configuration is also possible in which the profile acquisition part 131 and the angle determination part 132 are omitted, and the irradiation angle and the detection angle that have been obtained separately (for example, obtained by another device) are used instead. Moreover, the inspection part 134 may be omitted from the pattern inspection apparatuses 11 and 11a described in the above embodiments, and only the functions of the inspection-image acquisition apparatuses 110 and 110a may be used. The inspection-image acquisition apparatuses 110 and 110a may be used as image acquisition apparatuses when acquiring images that are to be used in various applications other than inspection. Various forms of the inspection part 134 are usable, and inspection does not necessarily need to be executed by comparison with the reference image.

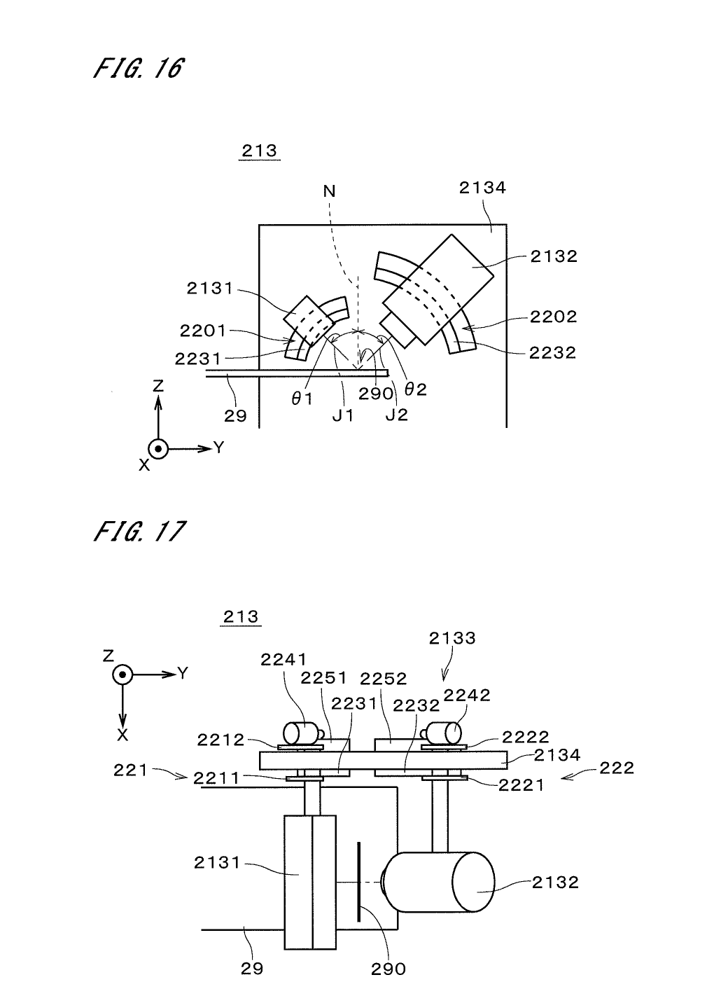

FIG. 15 is a diagram showing a schematic configuration of a pattern-image display apparatus 21 according to a fourth embodiment of the present invention. The pattern-image display apparatus 21 that serves as an image acquisition apparatus acquires and displays a pattern image that is an image of a multilayer thin film pattern formed on a base material. In FIG. 15, the base material is a glass substrate. The thin film pattern is, for example, a transparent electrode film, and in the present embodiment, the base material and the thin film pattern are covered with a transparent film. In actuality, other layers such as an antireflection film are also formed on the base material. In the following description, the thin film pattern is simply referred to as a “pattern”. The base material and the film on the base material are collectively referred to as a “glass substrate 29” or “object to be displayed”. The glass substrate 29 is used in the manufacture of a capacitance-operated touch panel.

The pattern-image display apparatus 21 includes a moving mechanism 211 for moving the glass substrate 29, a film thickness measurement part 212, an image acquisition part 213, an auxiliary imaging part 214, and a computer 23. The moving mechanism 211 includes a stage 241 that holds the glass substrate 29 on the upper surface, an X-direction movement part 242 that moves the stage 241 in the X direction in FIG. 15 that is parallel to the main surface of the glass substrate 29, and a Y-direction movement part 243 that moves the X-direction movement part 242 in the Y direction that is parallel to the main surface of the glass substrate 29 and that is perpendicular to the X direction. The moving mechanism 211 is a mechanism for moving the base material constituting a main portion of the glass substrate 29 relative to an image capturing region 290, which will be described later. Note that a mechanism for moving the stage 241 in the Z direction in FIG. 15 that is perpendicular to both the X direction and the Y direction, or a mechanism for turning the stage 241 around an axis that is parallel to the Z direction may be additionally provided in the moving mechanism 211.

The film thickness measurement part 212 is a spectral film thickness gauge of an optical interference type that irradiates the glass substrate 29 with measurement light and acquires the spectrum of reflected light. The film thickness of each layer is obtained by, based on the assumption of a pre-set film structure, changing the mathematical film thickness of each layer and fitting the spectrum obtained by calculation to the spectrum acquired by measurement. In the auxiliary imaging part 214, a plurality of light receiving elements are arranged in a two-dimensional array, and an image of the glass substrate 29 is acquired. The image acquired by the auxiliary imaging part 214 is referred to as an “auxiliary image” in order to distinguish it from the image acquired by the image acquisition part 213.

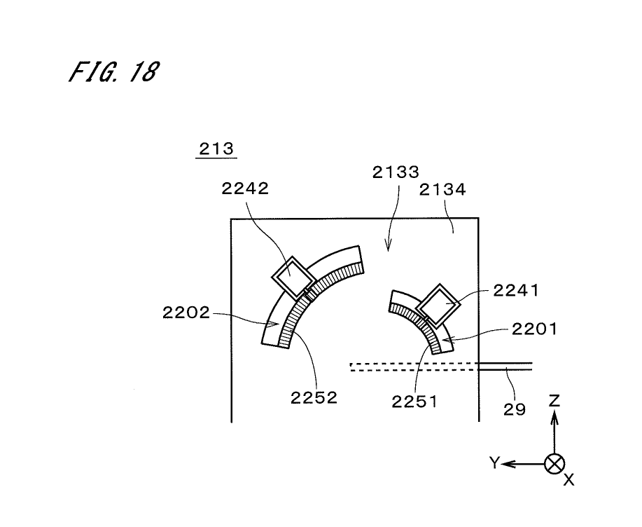

FIG. 16 is a front view of the image acquisition part 213, FIG. 17 is a plan view thereof, and FIG. 18 is a rear view thereof. The image acquisition part 213 includes a light irradiation part 2131 that emits light to an image capturing region 290 on the glass substrate 29, a line sensor 2132 that receives reflected light from the image capturing region 290, and an angle change mechanism 2133 for changing a light irradiation angle of the light irradiation part 2131 and a detection angle of the line sensor 2132. Here, the irradiation angle is an angle θ1 formed by an optical axis J1 from the light irradiation part 2131 to the image capturing region 290 and a normal line N of the glass substrate 29. The detection angle is an angle θ2 formed by an optical axis J2 from the image capturing region 290 to the line sensor 2132 and the normal line N.

The light irradiation part 2131 emits light of a wavelength having the property of passing through a pattern. At least the line-shaped image capturing region 290 is irradiated with the light. The light irradiation part 2131 includes a plurality of LEDs arranged in the X direction and an optical system that homogenizes light from the LEDs and guides the homogenized light to the image capturing region 290. The line sensor 2132 includes a one-dimensional image sensor and an optical system that provides an optically conjugate relationship between the image capturing region 290 and a light receiving surface of the image sensor. Note that an autofocus mechanism for moving the light irradiation part 2131, the line sensor 2132, and the angle change mechanism 2133 as a single unit in the direction of the normal line N of the glass substrate 29 may be provided in the image acquisition part 213.

When acquiring a pattern image as described later, the glass substrate 29 is moved in a direction intersecting the image capturing region 290 by the moving mechanism 211. Specifically, the moving mechanism 211 is a mechanism for moving the base material of the glass substrate 29 relative to the image capturing region 290. While in the present embodiment, the glass substrate 29 moves in the Y direction that is perpendicular to the image capturing region 290, the image capturing region 290 may be inclined with respect to the direction of the movement. It can be considered that the image acquisition part 213 includes part of the moving mechanism 211.

Note that in the following description, the base material and the pattern are distinguished from each other as necessary, but in the description about handling or the like of the object to be displayed, the base material and the object to be displayed are not strictly distinguished from each other because most part of the object to be displayed (glass substrate 29) is made up of the base material.

The angle change mechanism 2133 changes the irradiation angle θ1 and the detection angle θ2 while keeping the irradiation angle θ1 and the detection angle θ2 equal to each other. Thus, in the following description, the magnitude of the detection angle is equal to that of the irradiation angle, and the magnitude of the irradiation angle is equal to that of the detection angle. The light irradiation part 2131 and the line sensor 2132 are supported by a base wall 2134 via the angle change mechanism 2133. The base wall 2134 is a plate member that is parallel to the Y direction and the Z direction.

The base wall 2134 is provided with a first opening 2201 and a second opening 2202 both having the shape of an arc centered on the image capturing region 290. A first support part 221 that supports the light irradiation part 2131 is inserted in the first opening 2201. A second support part 222 that supports the line sensor 2132 is inserted in the second opening 2202. The first support part 221 and the second support part 222 are part of the angle change mechanism 2133. The angle change mechanism 2133 further includes a first guide part 2231, a first motor 2241, and a first rack 2251, which are for moving the light irradiation part 2131, and a second guide part 2232, a second motor 2242, and a second rack 2252, which are for moving the line sensor 2132.

The first guide part 2231 is provided along the first opening 2201 on the light irradiation part 2131 side of the base wall 2134 and guides movement of the light irradiation part 2131 in a circumferential direction around the image capturing region 290. A mobile unit 2211 of the first support part 221 moves along the first guide part 2231. The first support part 221 further includes a support plate 2212 on the side of the base wall 2134 opposite the light irradiation part 2131, and the first motor 2241 is supported by the support plate 2212. The first rack 2251 is provided along the first opening 2201 on the side of the base wall 2134 opposite the light irradiation part 2131. The first rack 2251 meshes with a pinion gear provided at an output shaft of the first motor 2241 and gives driving force to the first support part 221, thereby moving the light irradiation part 2131.

A mechanism for moving the line sensor 2132 is similar to that for moving the light irradiation part 2131. Specifically, the second guide part 2232 is provided along the second opening 2202 on the line sensor 2132 side of the base wall 2134 and guides movement of the line sensor 2132 in a circumferential direction around the image capturing region 290. A mobile unit 2221 of the second support part 222 moves along the second guide part 2232. The second support part 222 further includes a support plate 2222 on the side of the base wall 2134 opposite the line sensor 2132, and the second motor 2242 is supported by the support plate 2222. The second rack 2252 is provided along the second opening 2202 on the side of the base wall 2134 opposite the line sensor 2132. The second rack 2252 meshes with a pinion gear provided at an output shaft of the second motor 2242 and gives driving force to the second support part 222, thereby moving the line sensor 2132.

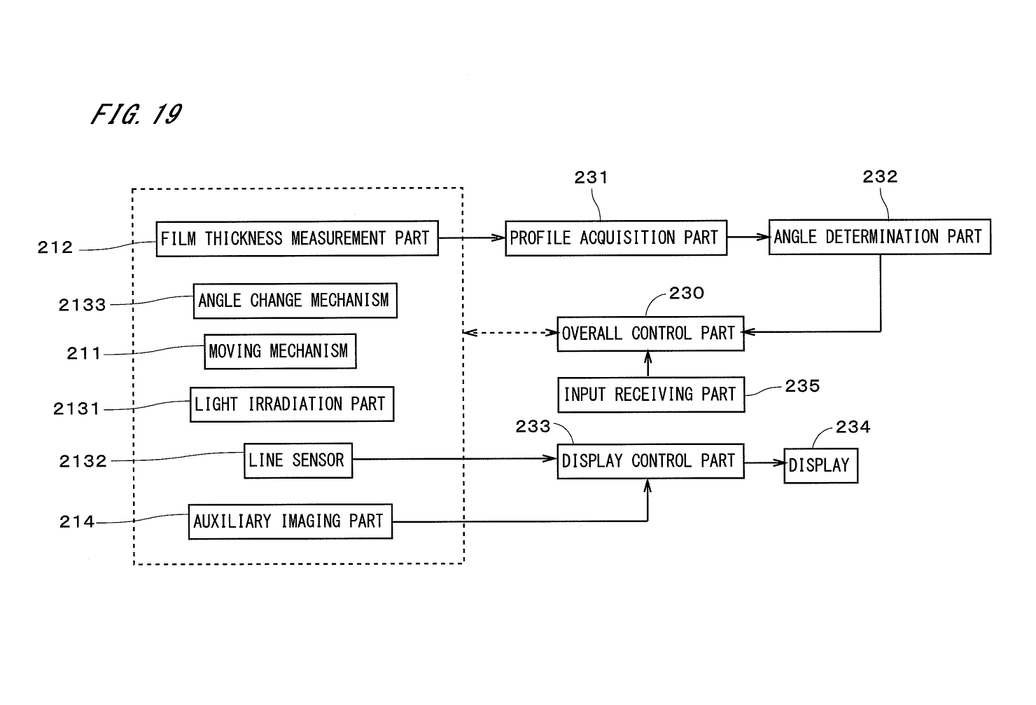

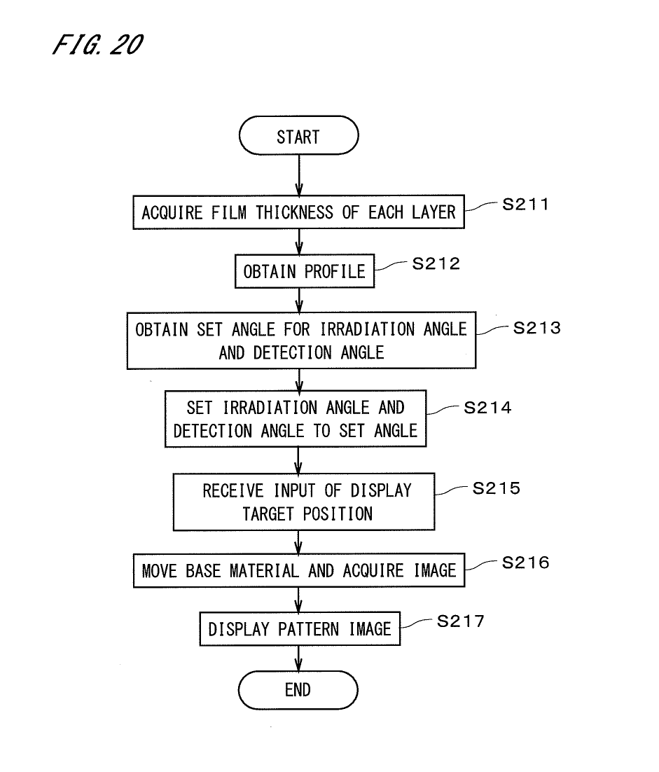

FIG. 19 is a block diagram showing a functional configuration of the pattern-image display apparatus 21. The configuration enclosed by the dashed line corresponds to the configuration shown in FIG. 15, and the other configurations are realized by the computer 23. The pattern-image display apparatus 21 includes a profile acquisition part 231 that receives output from the film thickness measurement part 212, an angle determination part 232 that receives a later-described profile obtained by the profile acquisition part 231, an overall control part 230 that performs overall control, a display control part 233 that receives output from the line sensor 2132, a display 234 serving as a display part, and an input receiving part 235 that receives input of various types of information from an operator or the like.

FIG. 20 is a flowchart of operations performed by the pattern-image display apparatus 21. In the pattern-image display apparatus 21, first the moving mechanism 211 is controlled such that a region of the glass substrate 29 in which a pattern is present is disposed under the film thickness measurement part 212 (specifically, at the position indicated by the chain double-dashed line in FIG. 15), and the film thickness measurement part 212 acquires the film thickness of each layer. By further controlling the moving mechanism 211, a background region that is a region around the pattern is disposed under the film thickness measurement part 212, and the film thickness of each layer in the background region is also acquired (step S211). Note that a configuration is also possible in which the thickness of each layer in only a region where a pattern is present is acquired, and the film thickness of each layer in the background is estimated based on the acquired film thicknesses.

The results of the measurement of the film thicknesses are input to the profile acquisition part 231. In the profile acquisition part 231, a profile indicating the relationship between the (irradiation angle and) detection angle and the contrast is obtained by calculation based on the layer structure on the base material and the film thickness of each layer (step S212). FIG. 21 is a diagram illustrating acquired profiles. A solid line 2811 indicates the relationship between the detection angle and the contrast in the case where a 900 nm-thick transparent film has been formed on a 30 nm-thick transparent electrode pattern. It is assumed that there is only the 900 nm-thick transparent film in the background. The irradiation light has a wavelength of 570 nm.

Here, the contrast refers to the ratio between the intensity of light incident upon the line sensor 2132 in the case where a multilayer film including a pattern is present on the base material and the intensity of light incident upon the line sensor 2132 in the case where the above multilayer film but that does not include the pattern is present on the base material. In other words, the contrast is the ratio in brightness between the pattern and the background (=(brightness in pattern region)/(brightness in background region)). The brightness corresponds to reflectance at that wavelength, and thus the ratio in brightness is also the ratio in reflectance. Of course, other values such as a difference in brightness or reflectance may be used as the contrast.

In FIG. 21, favorable pattern display is normally possible if the contrast is 0.5 or less or 2 or more. In the case of the solid line 2811, an appropriate pattern image can be obtained if the detection angle is approximately in the range of 0° to 28° or in the range of 40° to 45°. It is, however, to be noted that the upper-limit angle of 45° in FIG. 21 is merely one example. Note that if the contrast is 0.77 or less or 1.3 or more, it is possible to perform pattern observation depending on conditions. However, the contrast is preferably 0.67 or less or 1.5 or more. Furthermore, “high contrast” refers to “good contrast” and means a state in which brightness and darkness are clearly distinguishable. “High contrast” does not necessarily mean that the value of the contrast is high.

A dashed line 2812 in FIG. 21 indicates the relationship between the detection angle and the contrast in the case where a 960 nm-thick transparent film has been formed on a 30 nm-thick transparent electrode pattern. It is assumed that there is only the 960 nm-thick transparent film in the background. A dashed dotted line 2813 indicates the relationship between the detection angle and the contrast in the case where a 1000 nm-thick transparent film has been formed on a 30 nm-thick transparent electrode pattern. It is assumed that there is only the 1000 nm-thick transparent film in the background. The irradiation light has a wavelength of 570 nm. As indicated by the curves 2811 to 2813, it is clear that the detection angle at which a high-contrast pattern image is obtained varies greatly with a change in the thickness of the transparent film.

Specifically, changing the detection angle changes the optical path length of light passing through each transparent layer and changes a state of interference of the light. As a result, even in the case where a high contrast cannot be obtained at a specific detection angle, it is possible to obtain a high contrast by changing the detection angle without changing the wavelength. In other words, image acquisition that is equivalent to pattern image acquisition involving selecting a wavelength from among a large number of wavelengths with use of a white light source and a large number of filters can be realized by changing the detection angle.

In the angle determination part 232, an angle that is to be set for the irradiation angle and the detection angle (hereinafter referred to as a “set angle”) is determined based on the acquired profile (step S213). When determining the set angle, the movable ranges of the light irradiation part 2131 and the line sensor 2132 and other conditions are taken into consideration. The set angle is input to the overall control part 230, and the irradiation angle and the detection angle are set to the set angle by the overall control part 230 controlling the angle change mechanism 2133 (step S214).

When the above-described preparation operation has been completed, the input receiving part 235 receives input of coordinates indicating the desired display target position on the glass substrate 29 (step S215), and the display target position is disposed in the vicinity under the light irradiation part 2131 and the line sensor 2132 by the overall control part 230 controlling the moving mechanism 211. Then, light emission from the light irradiation part 2131 is started, and the moving mechanism 211 moves the glass substrate 29 in the Y direction such that the display target position passes through the image capturing region 290. In parallel with the movement of the glass substrate 29, the line sensor 2132 repeatedly acquires a line image of the line-shaped image capturing region 290 at high speed (step S216). Data of the line images is input to the display control part 233, as a result of which a two-dimensional pattern image indicating the thin film pattern at the display target position is displayed on the display 234 of the computer 23 (step S217). Note that a plurality of display target positions may be set in step S215, and pattern images at the plurality of display target positions may be sequentially acquired and displayed on the display 234.

As described above, displaying (visualizing) the image of the transparent thin film pattern formed as the transparent electrode film based on the output from the line sensor 2132 enables the operator to check the shape or the like of the thin film pattern, and makes it possible to, for example, improve the process of forming a thin film pattern. Meanwhile, in the pattern-image display apparatus 21, two arbitrary points are selected from the pattern image displayed on the display 234 through the input unit, and the distance between these two points is displayed (or output). Furthermore, it is also possible to, based on the data of the pattern image, display a cross-sectional profile at an arbitrary position, or display the distance between two arbitrary points in the cross-sectional profile.

It is also possible to designate an arbitrary position in the pattern image displayed on the display 234 and display the coordinates of that position (coordinates relative to a reference position) by registering the reference position and orientation of the glass substrate 29 on the stage 241 in advance. When various types of measurements are performed on the glass substrate 29 with other measurement devices, it is difficult to specify a measurement position in accordance with a thin film pattern. However, using the above-described coordinates acquired by the pattern-image display apparatus 21 enables a measurement position to be easily specified by such measurement devices.

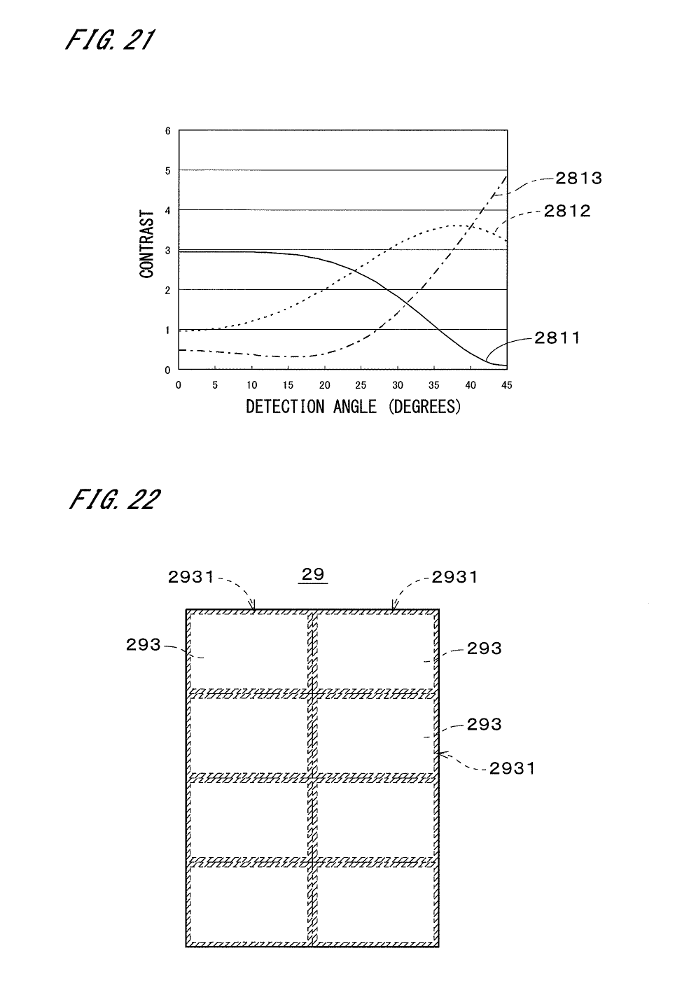

In the pattern-image display apparatus 21, the display target position may be input based on the auxiliary image acquired by the auxiliary imaging part 214. For example, in the glass substrate 29 shown in FIG. 22, a plurality of rectangular regions 293, each forming a touch panel, are set on the main surface, and a predetermined pattern (e.g., a pattern of extraction electrodes connected to the transparent electrode film, which is hereinafter referred to as a “visible pattern”) 2931 is formed from a metal material at the outer edges of the rectangular regions 293. In such a case, although the thin film pattern of the transparent electrode film is not distinguishable from the background in the auxiliary image acquired by the auxiliary imaging part 214, the visible pattern 2931 is visually recognizable. Accordingly, the glass substrate 29 is moved in the X and Y directions by the operator performing predetermined input while referring to the visible pattern 2931 in the auxiliary image, and the desired region on the glass substrate 29 is disposed within the capturing range of the auxiliary imaging part 214. As a result, an auxiliary image of that region is displayed on the display 234.

As a result of the operator making input that instructs the desired position in the auxiliary image as the display target position, the input receiving part 235 receives that input (step S215), and the display target position on the glass substrate 29 is disposed in the vicinity under the light irradiation part 2131 and the line sensor 2132. Then, light emission from the light irradiation part 2131 is started, and the moving mechanism 211 moves the glass substrate 29 in the Y direction such that the display target position passes through the image capturing region 290. As a result, a pattern image of the thin film pattern at the display target position is acquired and displayed on the display 234 (steps S216 and S217). Note that a pattern image of substantially the entire region on the glass substrate 29 in the auxiliary image may be acquired. Alternatively, the auxiliary image and the pattern image may be displayed separately on two displays, in which case the two displays serve as the display part. Moreover, instead of the pattern of extraction electrodes, the visible pattern may, for example, be outer edges (usually formed from a metal material) or the like of cells that constitute pixels in a panel for the display device.

As described above, the pattern-image display apparatus 21 can acquire and display a pattern image that has a high contrast between the pattern and the background, without changing the wavelength of the light used to irradiate the image capturing region 290. This eliminates the need to provide a complicated configuration for changing the wavelength, to design an optical system in conformity with light of multiple wavelengths, or to make complex adjustment, thus making it possible to reduce the manufacturing cost of the pattern-image display apparatus 21. Furthermore, for example, even if a light-sensitive resist is included in a layer on the pattern, display of the pattern image can be easily performed while avoiding light of a wavelength that cannot be used.

Moreover, because the profile acquisition part 231 acquires a profile, the angle determination part 232 can easily determine the most preferable angle. Using the film thickness measurement part 212 makes it possible to acquire a profile promptly and to display a pattern image with high efficiency. In the pattern-image display apparatus 21, the pattern image at the display target position is automatically acquired by the input receiving part 235 receiving input that indicates the display target position on the glass substrate 29. Thus, an image at the desired position on the glass substrate 29 can be easily displayed on the display 234. Furthermore, the auxiliary imaging part 214 acquires an auxiliary image of the glass substrate 29, and the overall control part 230 controls the moving mechanism 211 such that the position on the glass substrate 29 shown in the auxiliary image passes through the image capturing region 290. In this case as well, the pattern image at the desired position on the glass substrate 29 can be easily displayed on the display 234.

As described previously with reference to FIG. 8, in practice, the pattern preferably has a thickness of 10 nm or more. In the case where the pattern is formed from a transparent electrode, the thickness of the pattern is usually 100 nm or less. Even in the case where a transparent pattern is formed from a different type of film, the thickness of the pattern is usually 2000 nm or less. Note that various materials are applicable to the pattern, and for example, the pattern may be formed from a thin chromium film.

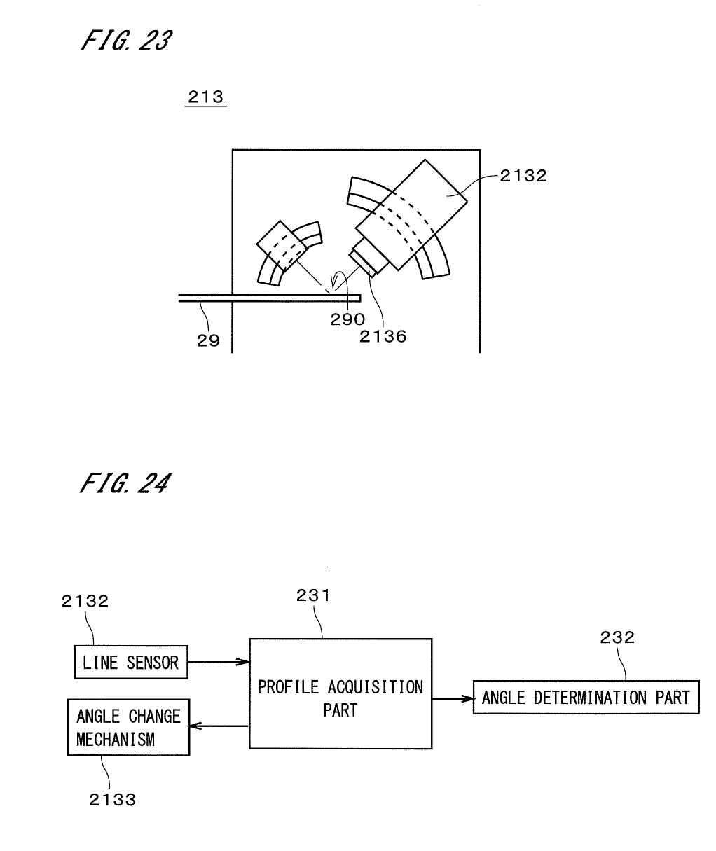

FIG. 23 is a front view showing another example of the image acquisition part 213. In the image acquisition part 213 shown in FIG. 23, a polarizer 2136 is disposed between the image capturing region 290 and the line sensor 2132. As a result, only p-polarized light out of the reflected light from the glass substrate 29 is incident on the line sensor 2132. The other configurations of the pattern-image display apparatus 21 are the same as in FIG. 15.

In the pattern-image display apparatus 21 including the image acquisition part 213 of FIG. 23, a profile regarding the p-polarized light is acquired by the profile acquisition part 231. Specifically, the change of the contrast depending on the detection angle, the contrast being the ratio between the intensity of the p-polarized light from a region in which the pattern is formed and the intensity of the p-polarized light from the background, is acquired as the profile (see FIGS. 10A to 10C described above).

It is clear that in the film structures shown in FIGS. 10B and 10C, a higher-contrast pattern image can be acquired by using the p-polarized light as compared with the case of not using the polarized light. Furthermore, it is also clear that a preferable detection angle greatly varies depending on the thickness of the transparent film.

In the pattern-image display apparatus 21, the irradiation angle and the detection angle are determined based on the profile regarding the p-polarized light. Then, a high-contrast image is acquired and displayed by the line sensor 2132 receiving the p-polarized light. This improves the accuracy of pattern observation. Note that if a higher-contrast patter image can be acquired by receiving the s-polarized light rather than receiving the p-polarized light, the line sensor 2132 is provided with another polarizer 2136 for receiving the s-polarized light. Using the polarized light is particularly suitable for the case where the pattern is extremely thin.

As described previously with reference to FIGS. 11A to 11D, a higher-contrast image can be acquired and displayed by using the p-polarized light as compared with the case of not using the polarized light. Furthermore, in practice, pattern observation using the contrast is possible if the pattern has a film thickness of 10 nm or more. In general, in the case where the pattern is thin, a high contrast can be obtained by increasing the detection angle.

FIG. 24 is a diagram showing functional configuration around the profile acquisition part 231 of a pattern-image display apparatus 21 according to a fifth embodiment. In the fifth embodiment, the film thickness measurement part 212 is omitted from the pattern-image display apparatus 21. The other configurations are the same as in the fourth embodiment, and the same reference numerals have been given to constituent elements that are the same as in the fourth embodiment.

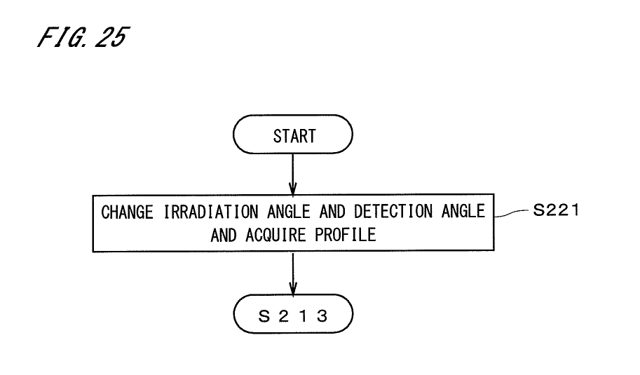

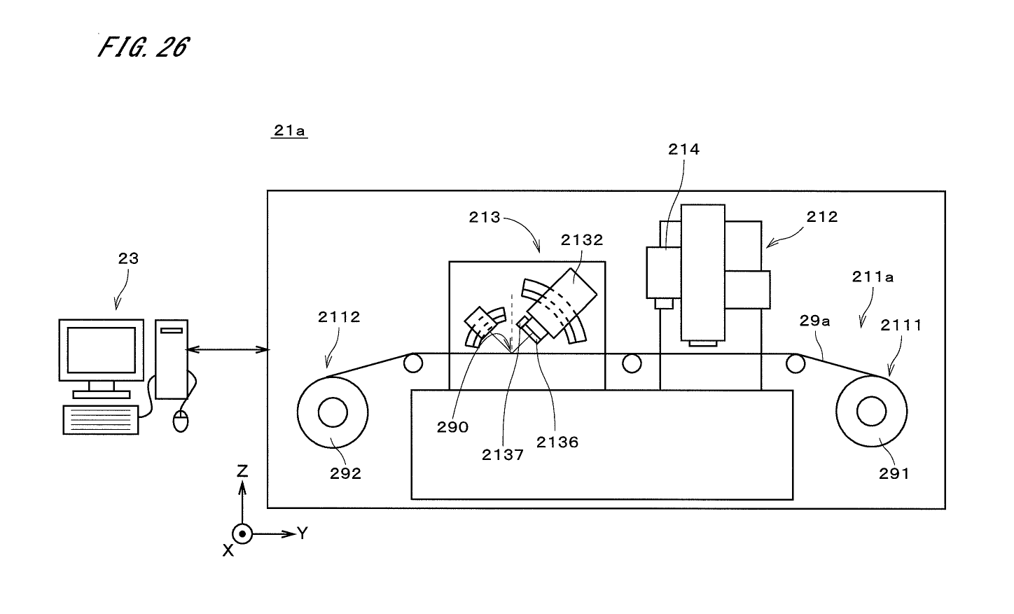

The profile acquisition part 231 controls the angle change mechanism 2133 and receives input of signals from the line sensor 2132. When acquiring a profile, first the moving mechanism 211 positions the glass substrate 29 such that both the pattern and the background are present in the image capturing region 290. Next, the line sensor 2132 repeatedly acquires a line image of the image capturing region 290 while the irradiation angle and the detection angle are changed by the profile acquisition part 231. In the profile acquisition part 231, every time a line image has been acquired by the line sensor 2132, the ratio between the intensity of light from the pattern region and the intensity of light from the background region is obtained as the contrast. The irradiation angle and the detection angle are changed from the smallest to the largest while being kept equal to each other. As a result, a profile indicating the relationship between the detection angle and the contrast is acquired (FIG. 25: step S221).

The acquired profile is sent to the angle determination part 232, in which the set angle is then determined (FIG. 20: step S213). Hereinafter, display of the pattern image is executed through the same operations as in the fourth embodiment.

In the fifth embodiment as well, a pattern image that has a high contrast between the pattern and the background can be acquired and displayed without changing the wavelength of the light used to irradiate the image capturing region 290. This makes it possible to reduce the manufacturing cost of the pattern-image display apparatus 21. Furthermore, because the film thickness measurement part is omitted, the manufacturing cost of the pattern-image display apparatus 21 can be further reduced.

FIG. 26 is a diagram showing a pattern-image display apparatus 21a according to a sixth embodiment. The pattern-image display apparatus 21a includes a conveying mechanism 211a, a film thickness measurement part 212, an image acquisition part 213, an auxiliary imaging part 214, and a computer 23. The configuration is the same as in the fourth embodiment, with the exception that the configuration of the conveying mechanism 211a and part of the image acquisition part 213 differ from those in FIG. 15. An object to be displayed is a web of resin film on which a transparent electrode film, a transparent film, and the like are formed, i.e., a continuous sheet.

The conveying mechanism 211a includes a supply part 2111 located on the right side ((+Y) side) in FIG. 26 and a collection part 2112 located on the left side ((−Y) side). The supply part 2111 supports the web 29a in the form of a roll 291 and feeds out the web 29a in the leftward direction. The collection part 2112 supports the web 29a in the form of a roll 292 and collects the web 29a. The conveying mechanism 211a is a moving mechanism for moving the base material constituting a main portion of the web 29a, relative to the image capturing region 290. Although the image capturing region 290 is provided substantially across the entire width of the web 29a in the pattern-image display apparatus 21a in FIG. 26, a configuration is also possible in which the length of the image capturing region 290 is smaller than the width of the web 29a, and a mechanism for moving the image acquisition part 213 in the X direction is additionally provided.

The film thickness measurement part 212, the auxiliary imaging part 214, and the image acquisition part 213 are disposed in the order specified from the supply part 2111 side toward the collection part 2112. In the image acquisition part 213, a polarizer 2136 is disposed between the image capturing region 290 and the line sensor 2132, and a rotation mechanism 2137 for rotating the polarizer 2136 about the optical axis is further provided. The rotation mechanism 2137 is a polarization switching mechanism for changing the direction of polarization by the polarizer 2136.

When performing display of a pattern image, the web 29a is disposed under the film thickness measurement part 212. Then, the film thickness of each layer on the base material of the web 29a is acquired (FIG. 20: step S211). Following this, based on the measurement result from the film thickness measurement part 212, the profile acquisition part 231 acquires, as profiles, a first profile indicating a first contrast obtained with p-polarized light between the pattern and the background, and a second profile indicating a second contrast obtained with s-polarized light between the pattern and the background (step S212).

The angle determination part 232 obtains the product of the first contrast and the second contrast and determines an angle at which the product differs greatly from 1, as the set angle (step S213). This method is suitable for the case where both the first contrast and the second contrast are close to 1, but the product of these contrasts is relatively different from 1.

Note that as long as it is possible to substantially obtain the product of the first contrast and the second contrast, the first profile and the second profile do not necessarily need to be prepared in a strict sense. For example, a value corresponding to the product of the first contrast and the second contrast may be obtained by obtaining the ratio between the product of the brightness of the p-polarized light and the brightness of the s-polarized light in the pattern and the product of the brightness of the p-polarized light and the brightness of the s-polarized light in the background. In this manner, the profile acquisition part 231 and the angle determination part 232 do not necessarily need to be distinguishable functions in a strict sense.

When the irradiation angle and the detection angle have been set to the set angle (step S214), input that indicates the display target position is received (step S215). Then, the display target position on the web 29a is disposed under the image acquisition part 213, and light irradiation and movement of the web 29a are started. As a result, a first pattern image at the display target position is acquired with the p-polarized light by the image acquisition part 213. Furthermore, after the polarizer 2136 has been rotated by the rotation mechanism 2137, light irradiation and movement of the web 29a (movement in a direction opposite the direction of the previous movement) are performed again, and a second pattern image at the display target position is acquired with the s-polarized light (step S216).

In the display control part 233, the product of each pixel value in the first pattern image and each corresponding pixel value in the second pattern image is obtained, and an image that has the obtained products as its pixel values is displayed as a pattern image (step S217). Since the pattern-image display apparatus 21a performs display of the pattern image using the product of the intensity of the p-polarized light and the intensity of the s-polarized light, appropriate image display can be realized when a difference in the product between the pattern and the background is large. Also, the influence of noise or the like can be reduced as a result of using two different types of images. In the pattern-image display apparatus 21a as well, a mechanism for switching the wavelength of the light source is unnecessary. Accordingly, it is possible to reduce the manufacturing cost of the pattern-image display apparatus 21a.

In the pattern-image display apparatus 21a, display of the pattern image may be performed without the polarizer 2136 as in the fourth embodiment, or display of an image may be performed using only either the p-polarized light or the s-polarized light. Furthermore, a configuration is also possible in which the film thickness measurement part 212 is omitted and the operation shown in FIG. 25 is executed.

While the above has been a description of the fourth to sixth embodiments of the present invention, the above-described embodiments can be modified in various ways.

The base material of the object to be displayed is not limited to a film or a glass substrate, and may be formed from other materials such as a resin plate. The film structure formed on the base material may have various configurations as described above, and normally, it has a more complicated configuration than illustrated in the above-described embodiments. A pattern that is an object to be displayed is not limited to a single type, and may be of a plurality of types. In this case, when displaying the pattern of each object to be displayed, the other patterns overlapping with that pattern are regarded as the background.

While a single type of background has been described in the above embodiments, the background is not limited to a single type. If there are a plurality of types of backgrounds, a profile is obtained for each of the backgrounds, and the irradiation angle and the detection angle at which a high contrast is obtained for all of the backgrounds are determined by the angle determination part 232.

The thin film pattern may be composed of other materials as long as the pattern has a certain degree of transparency to the irradiation light, and the pattern does not necessarily need to be transparent to visible light. The pattern is not limited to a transparent electrode, and may be patterns for other applications. However, the pattern-image display apparatus is particularly suitable for display of a pattern image of a transparent electrode on which no shadow is cast even when the electrode is irradiated with visible light.

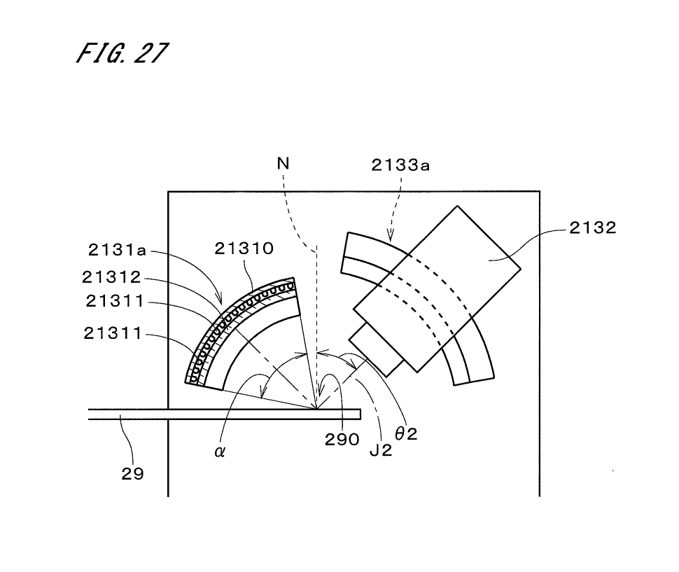

For example, a light irradiation part 2131a shown in FIG. 27 may be provided in a pattern-image display apparatus. In the light irradiation part 2131a in FIG. 27, a plurality of LEDs 21311 are arranged in a support part 21310 that has the shape of an arc centered on the image capturing region 290, and the image capturing region 290 is irradiated with light from the plurality of LEDs 21311 via a diffusion plate 21312. In this manner, the light irradiation part 2131a in FIG. 27 is configured to irradiate the image capturing region 290 with light in a predetermined angle range a that is centered on the image capturing region 290. In the pattern-image display apparatus including the light irradiation part 2131a, an angle change mechanism 2133a moves (turns) only the line sensor 2132 and does not move the light irradiation part 2131a. However, as long as on a plane that is perpendicular to the image capturing region 290, an angular position, which is inclined at only a detection angle θ2 from the normal line N of the glass substrate 29 on the side opposite the optical axis J2 with the image capturing region 290 as the center, is included in the angle range a, it can be considered that the optical axis from the light irradiation part 2131a to the image capturing region 290 is disposed at that angular position. Accordingly, the angle change mechanism 2133a in FIG. 27 for moving only the line sensor 2132 is also a mechanism for substantially changing the irradiation angle and the detection angle while keeping these angles equal to each other.

The moving mechanism for moving the base material relative to the image capturing region may be a mechanism for fixing the base material and moving the image acquisition part 213. The angle change mechanism 2133 may be a mechanism for linking the irradiation angle and the detection angle together, instead of a mechanism for individually changing the irradiation angle and the detection angle. In the angle change mechanism 2133, the irradiation angle and the detection angle do not necessarily need to be changed in a continuous manner, and they may be changed in only several steps, for example. Furthermore, the angle change mechanism 2133 may be configured to change these angles manually. Although in FIG. 26, the rotation mechanism 2137 is provided as the polarization switching mechanism, the polarization switching mechanism may be a mechanism for switching between two polarizers that have different directions of polarization.

The wavelength of the light emitted from the light irradiation part 2131 is not limited to a single waveform, and light of a plurality of wavelengths may be emitted selectively. The light source may be an LD, instead of an LED. Furthermore, a combination of a lamp, such as a halogen lamp, and filters may be provided as the light source. The film thickness measurement part 212 may be a spectral ellipsometer.

If the film structure and the film thickness of each layer of the object to be displayed are known, these pieces of information may be directly input to the profile acquisition part 231 by an operator, and the film thickness measurement part 212 may be omitted. Furthermore, a configuration is also possible in which the profile acquisition part 231 and the angle determination part 232 are omitted, and the irradiation angle and the detection angle that have been separately obtained are used instead.

As described above, changing the detection angle formed by the optical axis from the image capturing region to the light receiving part (including the line sensor) and the normal line of the base material changes the state of interference of the received light and enables accurate acquisition of a high-contrast image. In this case, if the detection angle is changed by turning the light receiving part, a position that has a conjugate relationship with the light receiving surface of the light receiving part will be shifted from the surface of the base material. Thus, a mechanism for moving the base material up and down in the vertical direction and disposing the position having a conjugate relationship with the light receiving surface on the surface of the base material (that is, a mechanism for performing focus adjustment) is necessary. However, this involves various constraints such as the necessity of a large-size up-and-down mechanism in order to move a large-size base material up and down, and in the case where images are simultaneously acquired at a plurality of positions on a base material, the impossibility of performing focus adjustment at the plurality of positions. The following describes another simple method for performing the focus adjustment of the light receiving part while changing the detection angle.

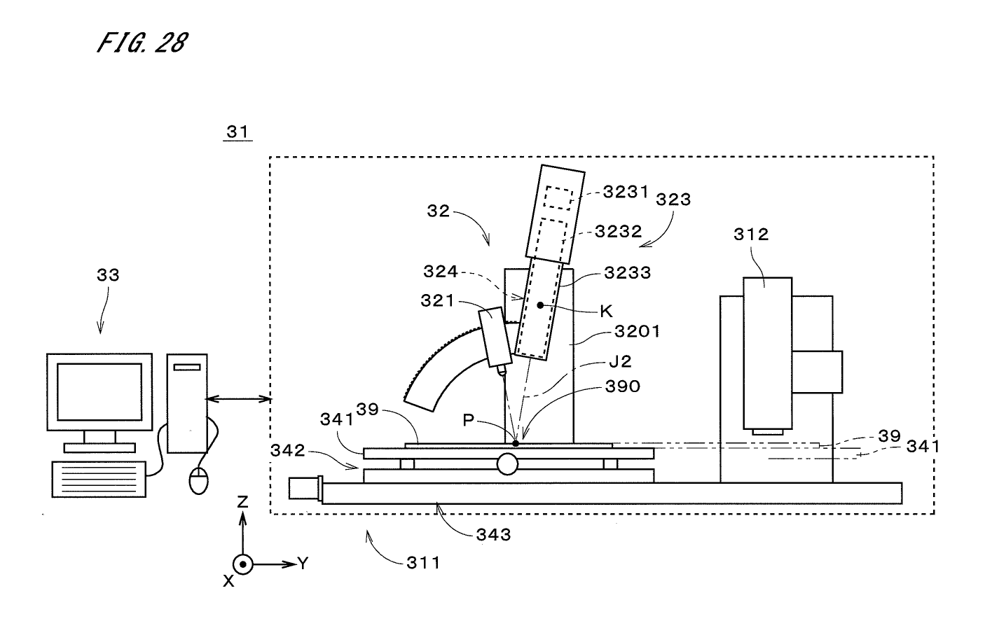

FIG. 28 is a diagram showing a schematic configuration of an image acquisition apparatus 31 according to a seventh embodiment of the present invention. The image acquisition apparatus 31 acquires and displays a pattern image that is an image of a multilayer thin film pattern formed on a base material. In FIG. 28, the base material is a glass substrate. The thin film pattern is, for example, a transparent electrode film, and in the present embodiment, the base material and the thin film pattern are covered with a transparent film. In actuality, other layers such as an antireflection film are also formed on the base material. In the following description, the thin film pattern is simply referred to as a “pattern”. The base material and the film on the base material are collectively referred to as a “glass substrate 39” or “object to be displayed”. The glass substrate 39 is used in the manufacture of a capacitance-operated touch panel.

The image acquisition apparatus 31 includes a moving mechanism 311 for moving the glass substrate 39, a film thickness measurement part 312, an imaging unit 32, and a computer 33. The moving mechanism 311 includes a stage 341 that holds the glass substrate 39 on the upper surface, a first movement part 342 that moves the stage 341 in the X direction in FIG. 28 that is parallel to the main surface of the glass substrate 39, and a second movement part 343 that moves the first movement part 342 in the Y direction that is parallel to the main surface of the glass substrate 39 and that is perpendicular to the X direction. The first movement part 342 and the second movement part 343 each include, for example, a motor, a ball screw, and a guide rail. The moving mechanism 311 is a mechanism for moving the base material constituting a main portion of the glass substrate 39, relative to an image capturing region 390, which will be described later. Note that a mechanism for turning the stage 341 around an axis that is parallel to the Z direction in FIG. 28, which is perpendicular to both the X direction and the Y direction, may be additionally provided in the moving mechanism 311.

The film thickness measurement part 312 is a spectral film thickness gauge of an optical interference type that irradiates the glass substrate 39 with measurement light and acquires the spectrum of the reflected light. The film thickness of each layer is obtained by, based on the assumption of a pre-set film structure, changing the mathematical film thickness of each layer and fitting the spectrum obtained by calculation to the spectrum acquired by measurement.

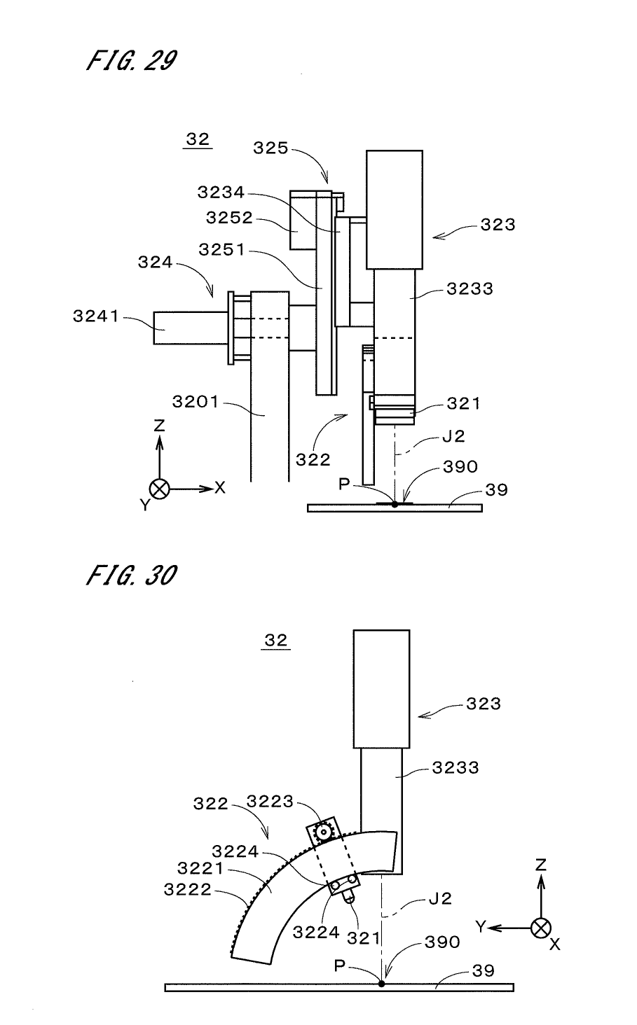

The imaging unit 32 includes a light irradiation part 321 that emits light to the image capturing region 390 on the glass substrate 39, and a light receiving part 323 that receives reflected light from the image capturing region 390. The light irradiation part 321 emits light of a wavelength having the property of passing through a pattern. At least the line-shaped image capturing region 390 (indicated by the thick line in FIG. 29 described later) that extends in the X direction is irradiated with the light. The light irradiation part 321 includes a plurality of LEDs arranged in the X direction and an optical system that homogenizes light from the LEDs and guides the homogenized light to the image capturing region 390. The light receiving part 323 includes a line sensor 3231 in which a plurality of light receiving elements are linearly arranged in a (one-dimensional) array, and an optical system 3232 that guides light from the image capturing region 390 to the line sensor 3231. The line sensor 3231 and the optical system 3232 are provided inside a lens barrel 3233. In FIG. 28, a position of the optical axis J2 of the optical system 3232 that has an optically conjugate relationship with the light receiving surface of the line sensor 3231 (that position is hereinafter referred to as a “focus position”) is indicated by a point P.

When acquiring a pattern image described later, the glass substrate 39 is moved in a direction intersecting the image capturing region 390 by the moving mechanism 311. Specifically, the moving mechanism 311 is a mechanism for moving the base material of the glass substrate 39 relative to the image capturing region 390. While in the present embodiment, the glass substrate 39 is moved in the Y direction that is perpendicular to the image capturing region 390, the image capturing region 390 may be inclined with respect to the movement direction. Note that in the following description, the base material and the pattern are distinguished from each other as necessary, but in the description about handling or the like of the object to be displayed, the base material and the object to be displayed are not strictly distinguished from each other because most part of the object to be displayed (glass substrate 39) is made up of the base material.

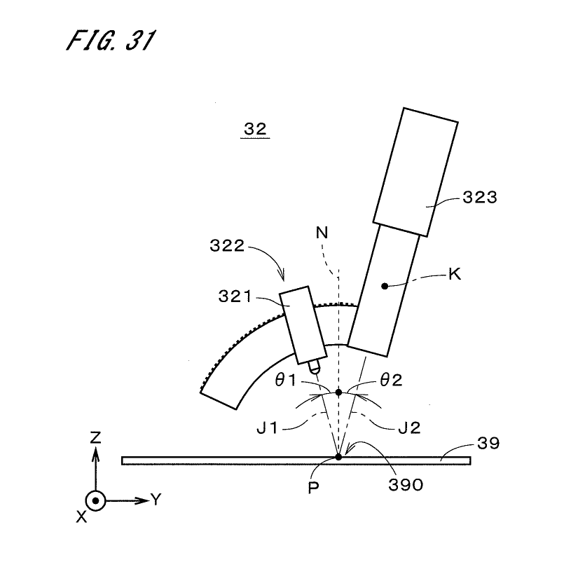

FIG. 29 is a side view of the imaging unit 32. In FIG. 29, for the convenience of illustration, the imaging unit 32 is shown in a state in which the optical axis J2 of the light receiving part 323 (of the optical system 3232) is parallel to the Z direction (the same applies to FIG. 30 described later). The imaging unit 32 further includes a light irradiation part-turning mechanism 322 for turning the light irradiation part 321 (see FIG. 30 described later), a light receiving part-turning mechanism 324 for turning the light receiving part 323, and a light receiving part-moving mechanism 325 for moving the light receiving part 323 along the optical axis J2.

The light receiving part-turning mechanism 324 includes a motor (e.g., a stepping motor) 3241 attached to a support block 3201, and the end of a rotary shaft of the motor 3241 is fixed to a base part 3251 of the light receiving part-moving mechanism 325. The base part 3251 has a shape that is long in one direction (hereinafter also referred to as a “longitudinal direction”). A guide rail that extends in the longitudinal direction, a ball screw that extends in the longitudinal direction, and a motor 3252 that rotates the ball screw via a transfer mechanism are attached to the base part 3251. A base part 3234 of the light receiving part 323 is fixed to a nut (moving part) of the ball screw, and the aforementioned lens barrel 3233 is attached to the base part 3234. In the imaging unit 32, the light receiving part 323 is moved in the longitudinal direction of the base part 3251 by driving the motor 3252. The longitudinal direction of the base part 3251 is parallel to the optical axis J2 of the light receiving part 323, and the light receiving part 323 can be moved along the optical axis J2 by the light receiving part-moving mechanism 325.

FIG. 30 is a rear view of the light irradiation part-turning mechanism 322. The light irradiation part-turning mechanism 322 includes a guide plate 3221 that has the shape of an arc centered on the focus position P, and the guide plate 3221 is fixed to the lens barrel 3233 of the light receiving part 323. The guide plate 3221 is a plate member that is parallel to the Y direction and the Z direction. The light irradiation part 321 is provided with a gear 3223 that rotates about an axis that is parallel to the X direction, and two guide rollers 3224. The guide plate 3221 has a rack 3222 at an arc-shaped edge on the outer side relative to the focus position P (i.e., out of the two arc-shaped edges, the one that is farther from the focus position P), and the gear 3223 meshes with the rack 3222. Furthermore, guide grooves that are engaged with the guide rollers 3224 are formed at the inner arc-shaped edge of the guide plate 3221. In the imaging unit 32, the light irradiation part 321 is moved along the arc-shaped edges of the guide plate 3221 by a motor (not shown) that rotates the gear 3223. Specifically, the light irradiation part-turning mechanism 322 turns the light irradiation part 321 around an axis (virtual axis) that is parallel to the image capturing region 390 and that passes through the focus position P. Note that the gear 3223 and the guide rollers 3224 are part of the light irradiation part-turning mechanism 322.

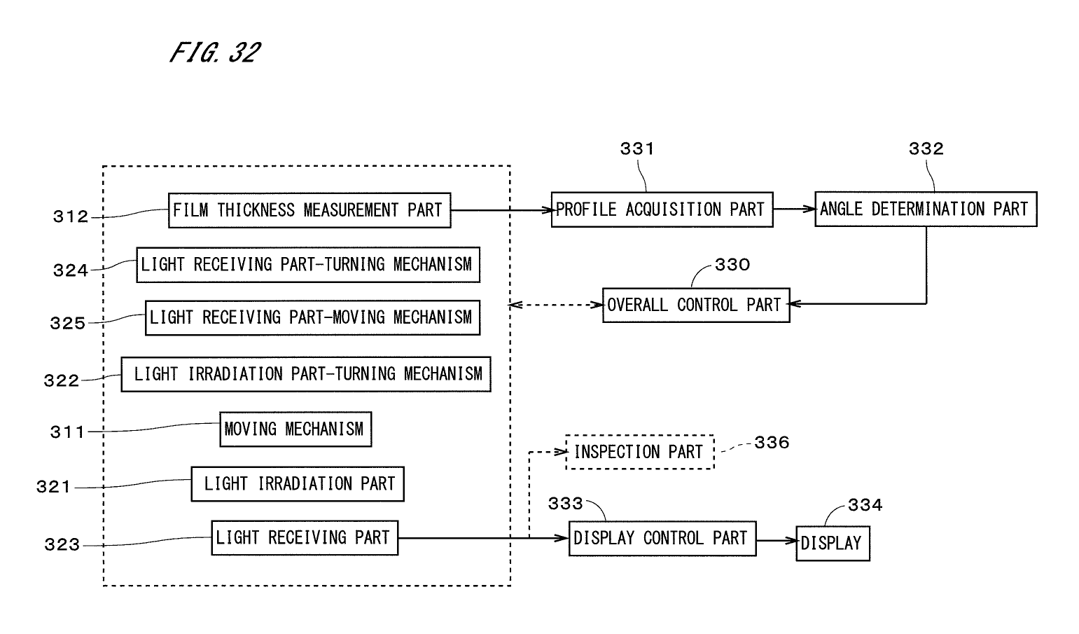

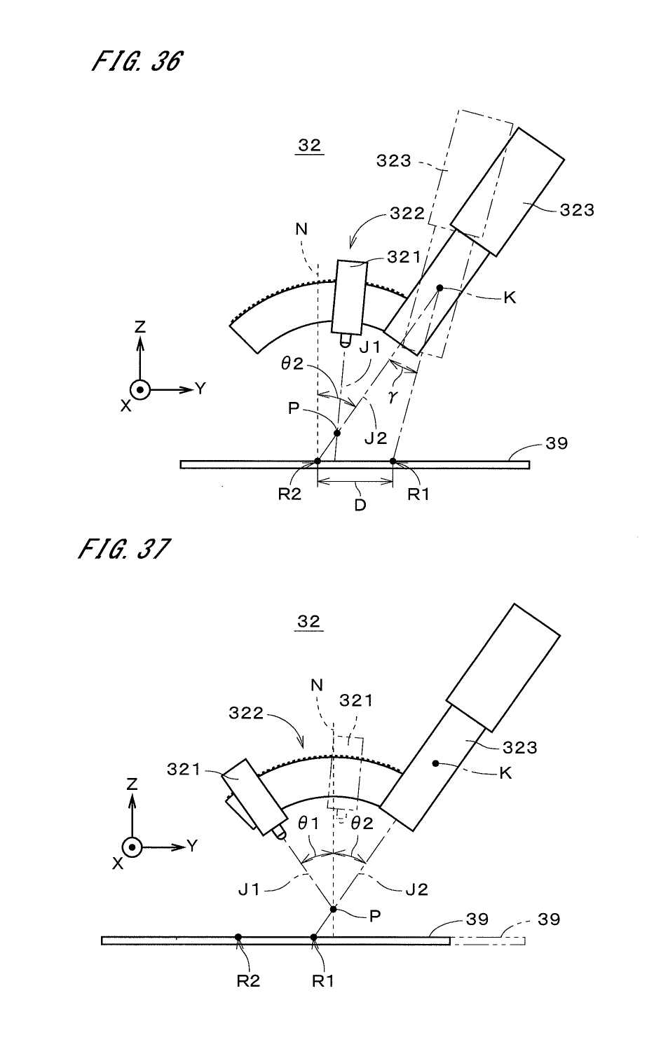

As described previously, in FIGS. 29 and 30, for the convenience of illustration, the imaging unit 32 is shown in a state in which the optical axis J2 of the light receiving part 323 (i.e., the direction of movement of the light receiving part 323) is parallel to the Z direction. However, in the actual imaging unit 32, the optical axis J2 from the image capturing region 390 to the light receiving part 323 is inclined with respect to the Z direction as shown in FIG. 31. Then, assuming the angle θ2 formed by the optical axis J2 of the light receiving part 323 and the normal line N of the glass substrate 39 as the detection angle, the detection angle θ2 is changed by the light receiving part-turning mechanism 324 (see FIG. 29). Furthermore, assuming the angle θ1 formed by the normal line N and the optical axis J1 from the light irradiation part 321 to the image capturing region 390 as the irradiation angle, the irradiation angle θ1 is changed by the light irradiation part-turning mechanism 322. In FIGS. 28 and 31, a rotation axis of the light receiving part-turning mechanism 324 is indicated by K (the same applies to FIGS. 36 to 38, 40, and 41 described later).

FIG. 32 is a block diagram showing a functional configuration of the image acquisition apparatus 31. The configuration enclosed by the dashed line corresponds to the configuration shown in FIGS. 28 to 30, and the other configurations are realized by the computer 33. The image acquisition apparatus 31 includes a profile acquisition part 331 that receives output from the film thickness measurement part 312, an angle determination part 332 that receives a later-described profile obtained by the profile acquisition part 331, an overall control part 330 that performs overall control, a display control part 333 that receives output from the light receiving part 323, and a display 334 serving as a display part.

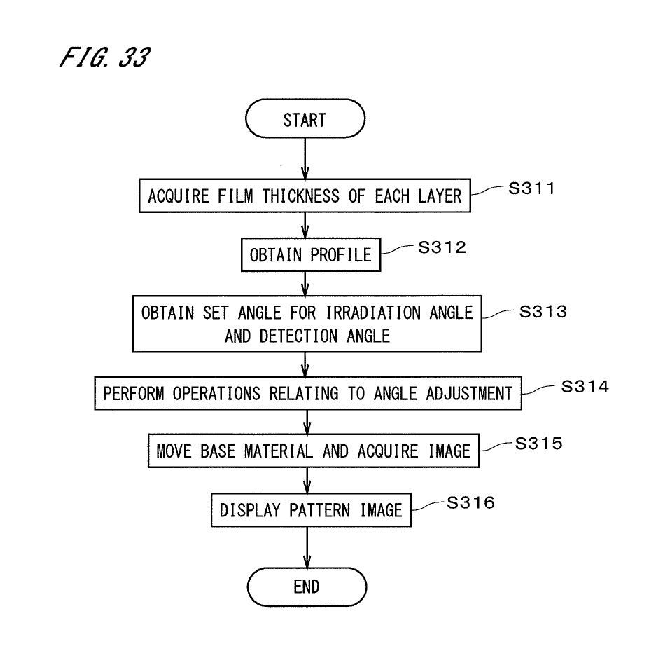

FIG. 33 is a flowchart of operations performed by the image acquisition apparatus 31. In the image acquisition apparatus 31, first the moving mechanism 311 is controlled such that the region of the glass substrate 39 in which a pattern is present is disposed under the film thickness measurement part 312 (i.e., at the position indicated by the chain double-dashed line in FIG. 28), and the film thickness measurement part 312 acquires the film thickness of each layer. By further controlling the moving mechanism 311, a background region that is a region around the pattern is disposed under the film thickness measurement part 312, and the film thickness of each layer in the background region is also acquired (step S311). Note that a configuration is also possible in which the thickness of each layer in only a region where a pattern is present is acquired, and the film thickness of each layer in the background is estimated based on the acquired film thicknesses.

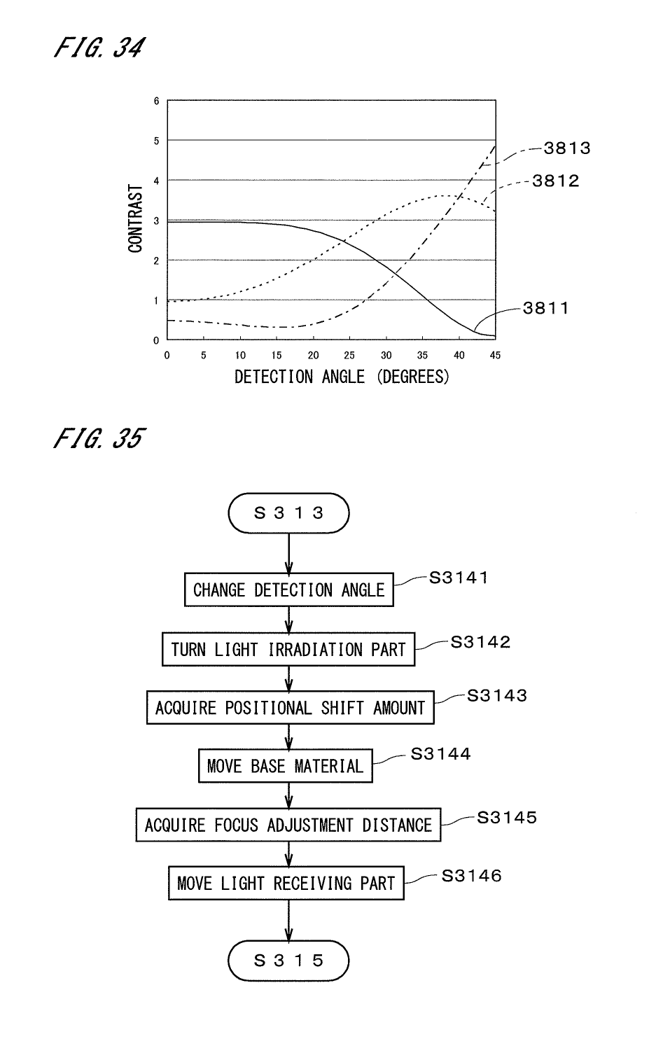

The results of the measurement of the film thicknesses are input to the profile acquisition part 331. In the profile acquisition part 331, a profile indicating the relationship between the (irradiation angle and) detection angle and the contrast is acquired by calculation based on the layer structure on the base material and the film thickness of each layer (step S312). FIG. 34 is a diagram illustrating acquired profiles. A solid line 3811 indicates the relationship between the detection angle and the contrast in the case where a 900 nm-thick transparent film has been formed on a 30 nm-thick transparent electrode pattern. It is assumed that there is only the 900 nm-thick transparent film in the background. The irradiation light has a wavelength of 570 nm. As described later, when acquiring an image in the imaging unit 32, the light irradiation part-turning mechanism 322 and the light receiving part-turning mechanism 324 are controlled such that the irradiation angle θ1 and the detection angle θ2 are made to be equal to each other. Accordingly, in the description of profiles, the magnitude of the detection angle is equal to that of the irradiation angle, and the magnitude of the irradiation angle is equal to that of the detection angle.

Here, the contrast refers to the ratio between the intensity of light incident upon the light receiving part 323 in the case where a multilayer film including a pattern is present on the base material and the intensity of light incident upon the light receiving part 323 in the case where the above multilayer film but that does not include the pattern is present on the base material. In other words, the contrast is the ratio in brightness between the pattern and the background (=(brightness in pattern region)/(brightness in background region)). The brightness corresponds to the reflectance at that wavelength, and thus the ratio in brightness is also the ratio in reflectance. Of course, other values such as a difference in brightness or reflectance may be used as the contrast.

In FIG. 34, favorable pattern display is normally possible if the contrast is 0.5 or less or 2 or more. In the case of the solid line 3811, an appropriate pattern image can be acquired if the detection angle is approximately in the range of 0° to 28° or in the range of 40° to 45°. It is, however, to be noted that the upper-limit angle of 45° in FIG. 34 is merely one example. Note that if the contrast is 0.77 or less or 1.3 or more, it is possible to perform pattern observation depending on conditions. However, the contrast is preferably 0.67 or less or 1.5 or more. Furthermore, “high contrast” refers to “good contrast” and means a state in which brightness and darkness are clearly distinguishable. “High contrast” does not necessarily mean that the value of the contrast is high.

A dashed line 3812 in FIG. 34 indicates the relationship between the detection angle and the contrast in the case where a 960 nm-thick transparent film has been formed on a 30 nm-thick transparent electrode pattern. It is assumed that there is only the 960 nm-thick transparent film in the background. A dashed dotted line 3813 indicates the relationship between the detection angle and the contrast in the case where a 1000 nm-thick transparent film has been formed on a 30 nm-thick transparent electrode pattern. It is assumed that there is only the 1000 nm-thick transparent film in the background. The irradiation light has a wavelength of 570 nm. As indicated by the curves 3811 to 3813, it is clear that the detection angle at which a high-contrast pattern image is obtained varies greatly with a change in the thickness of the transparent film.

Specifically, changing the detection angle changes the optical path length of light passing through each transparent layer and changes a state of interference of the light. As a result, even in the case where a high contrast cannot be obtained at a specific detection angle, it is possible to obtain a high contrast by changing the detection angle without changing the wavelength. In other words, image acquisition that is equivalent to pattern image acquisition involving selecting a wavelength from among a large number of wavelengths with use of a white light source and a large number of filters can be realized by changing the detection angle.

In the angle determination part 332, an angle that is to be set for the irradiation angle and the detection angle (hereinafter referred to as a “set angle”) is determined based on the acquired profile (step S313). When determining the set angle, the movable ranges of the light irradiation part 321 and the light receiving part 323 and other conditions are taken into consideration. The set angle is input to the overall control part 330, in which operations relating to the angle adjustment are then performed (step S314).

FIG. 35 is a flowchart of operations relating to the angle adjustment, and shows the process performed in step S314 in FIG. 33. In the operations relating to the angle adjustment, first the detection angle θ2 is changed to the set angle by the light receiving part-turning mechanism 324 (see FIG. 29) turning the light receiving part 323 (step S3141). In FIG. 36, the light receiving part 323 before the change of the detection angle θ2 is indicated by the chain double-dashed line, and the light receiving part 323 after the change of the detection angle θ2 is indicated by the solid line.

Then, the irradiation angle θ1 is changed to the set angle by the light irradiation part-turning mechanism 322 turning the light irradiation part 321 based on the amount γ of change in the detection angle θ2 of the light receiving part 323 (i.e., a difference in angle before and after the change of the detection angle θ2) (step S3142). In FIG. 37, the pre-turn light irradiation part 321 is indicated by the chain double-dashed line, and the turned light irradiation part 321 is indicated by the solid line. If the irradiation angle θ1 and the detection angle θ2 at the time immediately before the operations relating to the angle adjustment are equal to each other, the amount of change in the irradiation angle θ1 is two times the amount γ of change in the detection angle θ2, and the turning direction of the light irradiation part 321 is opposite the turning direction of the light receiving part 323.

In parallel with the above-described operations, the overall control part 330 acquires, based on the amount γ of change in the detection angle θ2, the distance (indicated by arrow D in FIG. 36 and hereinafter referred to as a “positional shift amount”) between a position (indicated by R1 in FIG. 36 and hereinafter referred to as a “position of interest R1”) at which the optical axis J2 of the light receiving part 323 before the change of the detection angle θ2 and the thin film pattern of the glass substrate 39 (i.e., the surface of the glass substrate 39) intersect with each other, and a position R2 at which the optical axis J2 after the change of the detection angle θ2 and the thin film pattern intersect with each other (step S3143). Then, the moving mechanism 311 moves the glass substrate 39 relative to the image capturing region 390 by the positional shift amount D in a direction from the position of interest R1 toward the position R2 (step S3144). As a result, the optical axis J2 after the change of the detection angle θ2 and the position of interest R1 on the glass substrate 39 intersect with each other as shown in FIG. 37.

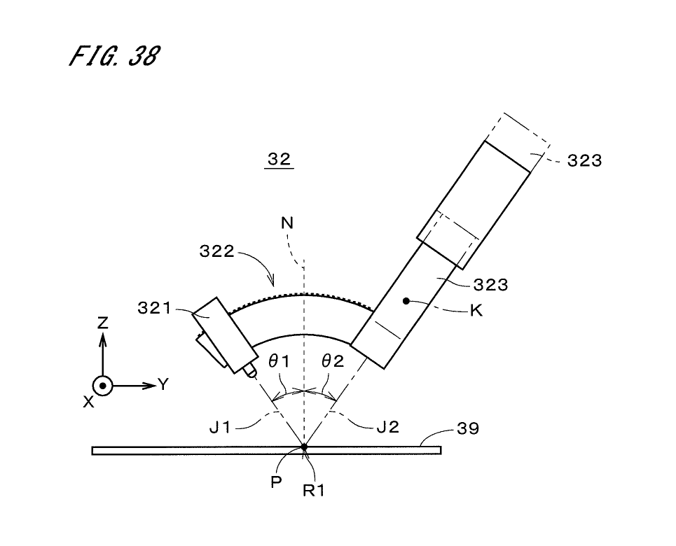

Furthermore, the overall control part 330 acquires, based on the amount γ of change in the detection angle θ2, the distance (hereinafter referred to as a “focus adjustment distance”) between the focus position P and the position at which the optical axis J2 and the surface of the glass substrate 39 intersect with each other (step S3145). Then, as shown in FIG. 38, the focus position P of the optical axis J2 that has a conjugate relationship with the light receiving surface of the line sensor 3231 is disposed at the position of interest R1 on the thin film pattern by the light receiving part-moving mechanism 325 moving the light receiving part 323 along the optical axis J2 by the focus adjustment distance (i.e., focus adjustment is performed) (step S3146). Through the above-described operations relating to the angle adjustment, the irradiation angle θ1 and the detection angle θ2 are set to the set angle, the image capturing region 390 is disposed at the same position relative to the glass substrate 39 as that before the change of the detection angle θ2, and the focus adjustment of the light receiving part 323 is completed.

Note that the change of the detection angle θ2 in step S3141, the turn of the light irradiation part 321 in step S3142, the movement of the glass substrate 39 in step S3144, and the movement of the light receiving part 323 in step S3146 may be performed substantially in parallel. The focus adjustment in which the focus position P is disposed on the thin film pattern may be performed through an autofocus operation. In the autofocus operation, for example, the light receiving part 323 is disposed at a plurality of positions that are sequentially spaced at a predetermined small distance from one another in the positive and negative directions of the optical axis J2 with the position indicated by the focus adjustment distance obtained in step S3145 as the center (the position indicated by the focus adjustment distance is included in the above plurality of positions), and line images are acquired by the line sensor 3231. Then, from among the plurality of positions, the light receiving part 323 is disposed at the position at which the amount of change (differential value) in pixel value at the edge of a portion corresponding to the thin film pattern in the cross-section profile shown in the line image is the largest (i.e., at the position at which the contrast is the highest). Note that it is desirable that the cross-section profile is displayed on the display 334 of the computer 33.

Furthermore, in the operations relating to the angle adjustment, fine adjustment of the angular position of the light irradiation part 321 may be performed. For example, the light irradiation part 321 is disposed at a plurality of angular positions that are sequentially spaced at a predetermined small angle from one another in the clockwise and counterclockwise directions from the angular position of the light irradiation part 321 after the change of the irradiation angle θ1, and line images are acquired by the line sensor 3231. Then, from among the plurality of angular positions, the light irradiation part 321 is disposed at the angular position at which the amount of change in pixel value at the edge of a portion corresponding to the thin film pattern in the cross-section profile shown in the line image is the largest. In this case, the above-described autofocus operation may be further performed.

Moreover, the operations relating to the angle adjustment may be performed at the timing instructed by the operator. For example, a configuration is possible in which the movement of the glass substrate 39 in step S3144 is performed by the operator selecting a stage movement button in a window displayed on the display 334 with clicking of a mouse or the like, and the positions at which the optical axis J2 of the light receiving part 323 and the surface of the glass substrate 39 intersect with each other, before and after the change of the detection angle θ2, are matched. Similarly, the above-described autofocus operation may be performed by the operator selecting an autofocus button in a window.

When the operations relating to the angle adjustment have been completed as described above (FIG. 33: step S314), light emission from the light irradiation part 321 is started, and the moving mechanism 311 continuously moves the glass substrate 39 in the Y direction. In parallel with the movement of the glass substrate 39, the line sensor 3231 in the light receiving part 323 repeatedly acquires a line image of the line-shaped image capturing region 390 at high speed (step S315). Data of the line images is input to the display control part 333, as a result of which data of a two-dimensional pattern image of the thin film pattern is acquired (i.e., stored), and the pattern image is displayed on the display 334 of the computer 33 (step S316).

As described above, displaying (visualizing) the image of the transparent thin film pattern formed as the transparent electrode film based on the output from the light receiving part 323 enables the operator to check the shape or the like of the thin film pattern and makes it possible to, for example, improve the process of forming a thin film pattern. Meanwhile, in the image acquisition apparatus 31, two arbitrary points are selected from the pattern image displayed on the display 334 through the input unit, and the distance between these two points is displayed (or output). Furthermore, it is also possible to, based on the data of the pattern image, display a cross-sectional profile at an arbitrary position, or display the distance between two arbitrary points in the cross-sectional profile.

Here, in the case where the focus adjustment is performed by moving a large-size glass substrate 39 up and down in the Z direction, a large-size up-and-down mechanism is required. As opposed to this, in the image acquisition apparatus 31, the focus position P of the optical axis J2 that has a conjugate relationship with the light receiving surface of the line sensor 3231 is disposed on the thin film pattern by the light receiving part-moving mechanism 325 moving the light receiving part 323 along the optical axis J2 based on the amount of change in the detection angle by the light receiving part-turning mechanism 324. This makes it possible to easily perform the focus adjustment of the light receiving part 323 while changing the detection angle.

Furthermore, in the imaging unit 32, the irradiation angle can be easily matched with the detection angle by the provision of the light irradiation part-turning mechanism 322 for turning the light irradiation part 321 around an axis that is parallel to the image capturing region 90 and that passes through the focus position P. Moreover, the positions of the image capturing region 390 relative to the glass substrate 39 before and after the change of the detection angle are matched by the overall control part 330 controlling the moving mechanism 311 based on the amount of change in the detection angle. This prevents the position of the image capturing region 390 relative to the glass substrate 39 to be shifted due to the change of the detection angle. As a result, for example, in the case where pattern images are acquired by changing the detection angle and the irradiation angle to various angles, it is possible to easily acquire images of the same region on the glass substrate 39.

In the image acquisition apparatus 31, a pattern image that has a high contrast between the pattern and the background can be acquired and displayed without changing the wavelength of the light used to irradiate the image capturing region 390. This eliminates the need to provide a complicated configuration for changing the wavelength, to design an optical system in conformity with light of multiple wavelengths, or to make complex adjustment, thus making it possible to reduce the manufacturing cost of the image acquisition apparatus 31. Furthermore, for example, even if a light-sensitive resist is included in a layer on the pattern, display of the pattern image can be easily performed while avoiding light of a wavelength that cannot be used.

In the image acquisition apparatus 31, pattern inspection may be performed in addition to the display of a pattern image. For example, an inspection part 336 is connected to the light receiving part 323 as indicated by a dashed-line rectangle in FIG. 32. When performing pattern inspection, data of a pattern image is acquired by the light receiving part 323 repeatedly outputting a line image to the inspection part 336 in synchronization with movement of the glass substrate 39. Furthermore, data of a reference image to be used as a reference is stored in the inspection part 336, and the presence or absence of defects is determined by comparing the data of the pattern image with the data of the reference image. Since pattern images are continuously acquired in the case where the image acquisition apparatus 31 is used as a pattern inspection apparatus, a sensor that detects the distance between the light receiving part 323 and the glass substrate 39 with respect to the direction of the optical axis J2 may be provided, and focus adjustment may be performed in real-time when acquiring a pattern image by moving the light receiving part 323 along the optical axis J2 based on output from the sensor. Furthermore, the inspection part 336 may be provided in other image acquisition apparatuses.

In the image acquisition apparatus 31, a configuration is possible in which a plurality of imaging units 32 are arranged in a staggered manner along the X direction as shown in FIG. 39, and a pattern image of the entire width of a glass substrate 39 is acquired through a single Y-direction movement of the glass substrate 39. Each of the imaging units 32 has the same configuration as that of the imaging unit 32 in FIGS. 29 and 30, with the exception that the support block 3201 is fixed to a top panel that is provided separately. In the image acquisition apparatus 31 in FIG. 39, the focus adjustment of the light receiving parts 323 of the plurality of imaging units 32 can be performed individually, so it is possible to easily handle waviness of the glass substrate 39, the inclination of the glass substrate 39 on the stage 341, and the like and accurately acquire a pattern image with the imaging units 32. Such a plurality of imaging units 32 may be provided in other image acquisition apparatuses.

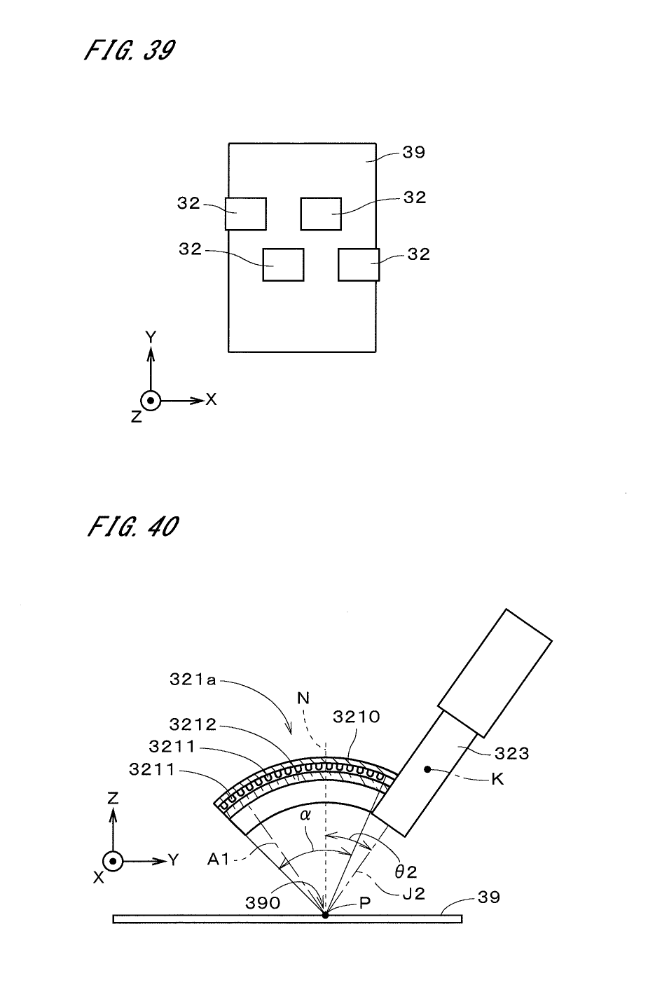

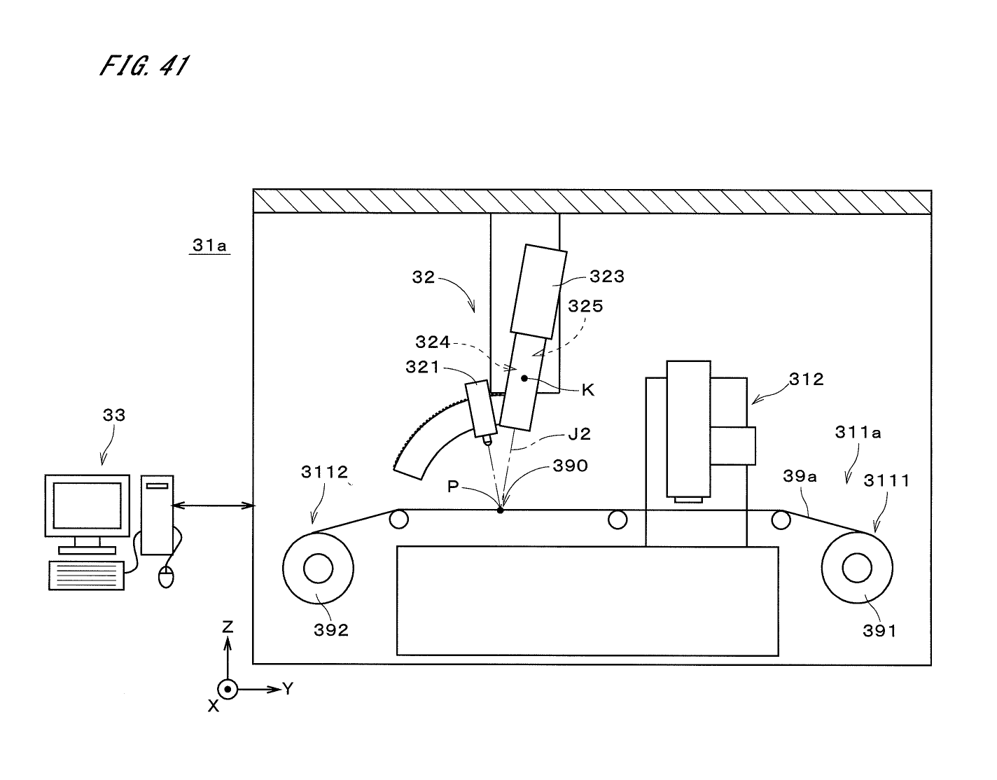

FIG. 40 is a diagram showing another example of the light irradiation part. In an imaging unit 32 including a light irradiation part 321a shown in FIG. 40, the light irradiation part-turning mechanism 322 is omitted. The light irradiation part 321a is provided with a support part 3210 that has the shape of an arc centered on an axis that is parallel to the line-shaped image capturing region 390 and that passes through the focus position P, and the support part 3210 is fixed to the light receiving part 323. In the support part 3210, a plurality of LEDs 3211 are arranged in an array, and light from the plurality of LEDs 3211 are homogenized via a diffusion plate 3212 and applied to the image capturing region 390. In this manner, the light irradiation part 321a in FIG. 40 is configured to irradiate the image capturing region 390 with light (i.e., emit the light toward the image capturing region 390) in a predetermined angle range a centered on an axis that is parallel to the image capturing region 390 and that passes through the focus position P.

In the imaging unit 32 including the light irradiation part 321a, as long as on a plane that is perpendicular to the axis, an angular position (indicated by the dashed dotted line A1 in FIG. 40) that is inclined at the detection angle θ2 from the normal line N of the glass substrate 39 on the side opposite the optical axis J2 with the axis as the center is included in the angle range a, it can be considered that the optical axis from the light irradiation part 321a to the image capturing region 390 is disposed at that angular position. The irradiation angle and the detection angle are made to be equal to each other. Accordingly, in the image acquisition apparatus 31 including the light irradiation part 321a, a high-contrast pattern image can be easily acquired. Furthermore, since a mechanism for turning the light irradiation part 321 is omitted, control of the imaging unit can be simplified. The light irradiation part 321a in FIG. 40 may be provided in other image acquisition apparatuses

FIG. 41 is a diagram showing another example of the image acquisition apparatus. An image acquisition apparatus 31a in FIG. 41 includes a conveying mechanism 311a, a film thickness measurement part 312, an imaging unit 32, and a computer 33. The configuration is the same as that of the image acquisition apparatus 31 in FIG. 28, with the exception that the configuration of the conveying mechanism 311a differs from that of the moving mechanism 311 in FIG. 28. An object to be displayed is a web of resin film on which a transparent electrode film, a transparent film, and the like are formed, i.e., a continuous sheet.

The conveying mechanism 311a includes a supply part 3111 located on the right side ((+Y) side) in FIG. 41, and a collection part 3112 located on the left side ((−Y) side). The supply part 3111 supports a web 39a in the form of a roll 391 and feeds out the web 39a in the leftward direction. The collection part 3112 supports the web 39a in the form of a roll 392 and collects the web 39a. The conveying mechanism 311a is a moving mechanism for moving the base material constituting a main portion of the web 39a relative to an image capturing region 390. Although the image capturing region 390 is provided substantially across the entire width of the web 39a in the image acquisition apparatus 31a in FIG. 41, a configuration is also possible in which the length of the image capturing region 390 is smaller than the width of the web 39a, and a mechanism for moving the imaging unit 32 in the X direction is additionally provided. The film thickness measurement part 312 and the imaging unit 32 are disposed in the order specified from the supply part 3111 side toward the collection part 3112. The operation performed by the image acquisition apparatus 31a for acquiring a pattern image is the same as that performed by the image acquisition apparatus 31 of FIG. 28.

In the image acquisition apparatus 31a, the focus position P is disposed on the surface of the web 39a by the light receiving part-moving mechanism 325 moving the light receiving part 323 along the optical axis J2. This makes it possible to easily perform the focus adjustment of the light receiving part 323 while changing the detection angle. Furthermore, since the mechanism for switching the wavelength of the light source is unnecessary, the manufacturing cost of the image acquisition apparatus 31a can be reduced.

While in the above-described image acquisition apparatuses 31 and 31a, a detection-angle change mechanism for changing the detection angle is realized by the light receiving part-turning mechanism 324 for turning the light receiving part 23, the detection-angle change mechanism may be realized by a mechanism for inclining the base material.

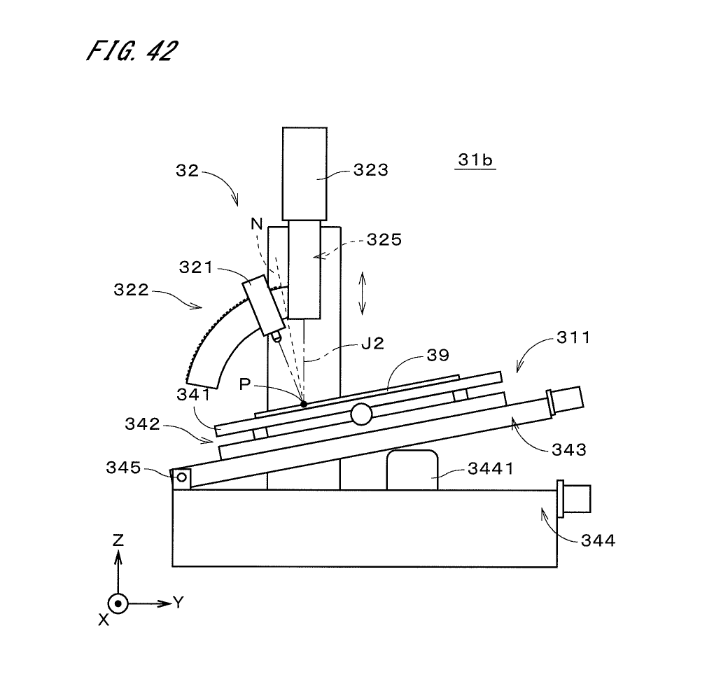

For example, in the image acquisition apparatus 31b in FIG. 42, the (−Y)-side end portion of the second movement part 343 of the moving mechanism 311 is supported by a support part 345 so as to be able to turn around an axis that is parallel to the X direction. Then, a sliding part-moving mechanism 344 moves a sliding part 3441 that abuts on the bottom surface of the second movement part 343 in the Y direction, as a result of which the glass substrate 39 is turned, centering on the support part 345 together with the moving mechanism 311, and the detection angle formed by the optical axis J2 of the light receiving part 323 and the normal line N of the glass substrate 39 is changed. In this manner, in the image acquisition apparatus 31b in FIG. 42, the detection-angle change mechanism is realized by the sliding part-moving mechanism 344 (and the support part 345), and the light receiving part-turning mechanism 324 in FIG. 28 is omitted. Furthermore, the focus position P is disposed on the surface of the glass substrate 39 by the light receiving part-moving mechanism 325 moving the light receiving part 323 along the optical axis J2 (i.e., in the Z direction). Then, a pattern image is acquired by the second movement part 343 moving the glass substrate 39.

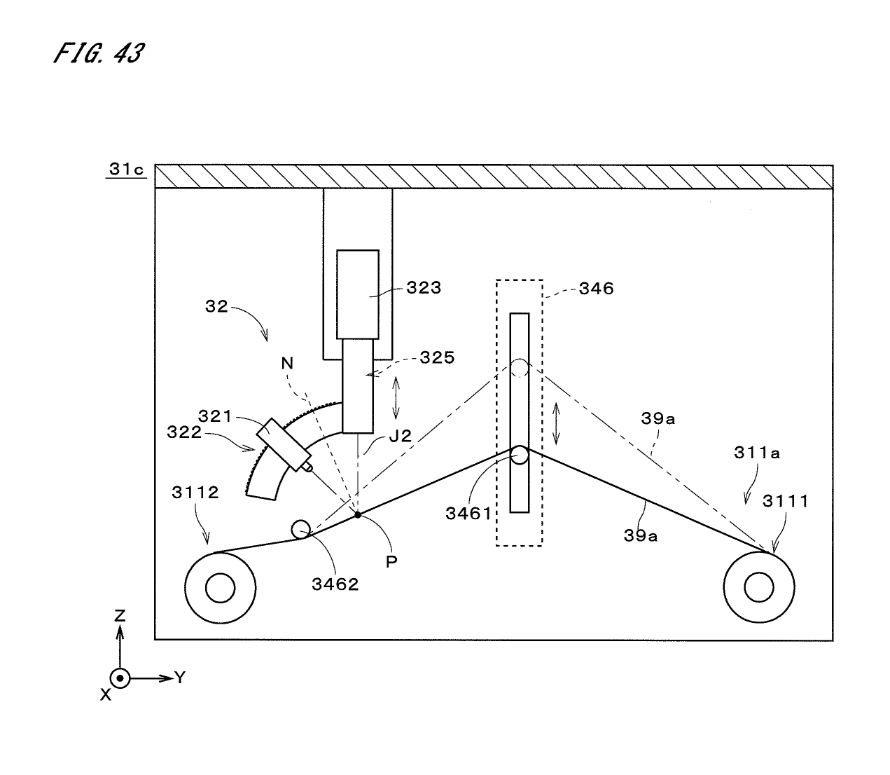

In an image acquisition apparatus 31c shown in FIG. 43, a roller 3461 that extends in the X direction is provided between a supply part 3111 and an imaging unit 32 with respect to the Y direction, and another roller 3462 that extends in the X direction is provided between a light receiving part 323 and a collection part 3112. The roller 3461 can be moved in the Z direction by a roller up-and-down mechanism 346, and the orientation of the normal line N of a web 39a in the vicinity under the imaging unit 32 is changed by changing the Z-direction position of the roller 3461. In the image acquisition apparatus 31c in FIG. 43, the detection-angle change mechanism for changing the detection angle formed by the optical axis J2 of the light receiving part 323 and the normal line N of the web 39a is realized by the roller up-and-down mechanism 346 (and the roller 3461), and the light receiving part-turning mechanism 324 in FIG. 28 is omitted. Furthermore, the focus position P is disposed on the surface of the web 39a by the light receiving part-moving mechanism 325 moving the light receiving part 323 along the optical axis J2 (i.e., in the Z direction). Then, a pattern image is acquired by a conveying mechanism 311a moving the web 39a. Note that in the image acquisition apparatuses 31 and 31a to 31c, the detection-angle change mechanism and the light receiving part-moving mechanism 325 are part of the angle change mechanism.

While the above has been a description of the seventh embodiment of the present invention, the above embodiment can be modified in various ways.

In the image acquisition apparatus 31, a profile indicating the relationship between the detection angle and the contrast may be acquired by changing the irradiation angle and the detection angle to a plurality of angles while keeping these angles equal to each other, and for each of the angles, obtaining, as the contrast, the ratio between the intensity of light from the pattern region and the intensity of light from the background region in a line image acquired by the light receiving part 323. In this case, the film thickness measurement part 312 is omitted from the image acquisition apparatus 31.

Furthermore, if a higher-contrast pattern image can be acquired by using either p-polarized light or s-polarized light as compared with the case of not using the polarized light, a polarizer may be disposed between the image capturing region 390 and the light receiving part 323. In this case, only the p- or s-polarized light out of the reflected light from the glass substrate 39 is incident on the light receiving part 323. Furthermore, the polarized light incident on the light receiving part 323 may be switched by providing a rotating mechanism for rotating the polarizer about the optical axis J2. Moreover, a first pattern image may be acquired based on the p-polarized light and a second pattern image may be acquired based the s-polarized light. In this case, for example, the product of each pixel value in the first pattern image and each corresponding pixel value in the second pattern image is obtained, and an image that has the obtained products as its pixel values is acquired as a pattern image. In such a pattern image, the influence of noise or the like in the image can be reduced as a result of using two different types of images.

The base material of the object to be displayed (or the object to be inspected) is not limited to a film or a glass substrate, and may be formed from other materials such as a resin plate. The film structure formed on the base material may have various configurations as described above, and normally, it has a more complicated configuration than illustrated in the above-described embodiments. A pattern that is an object to be displayed is not limited to a single type, and may be of a plurality of types. In this case, when displaying the pattern of each object to be displayed, the other patterns overlapping with that pattern are regarded as the background.

While a single type of background has been described in the above embodiment, the background is not limited to a single type. If there are a plurality of types of backgrounds, a profile is obtained for each of the backgrounds, and the irradiation angle and the detection angle at which a high contrast is obtained for all of the backgrounds are determined.

The thin film pattern may be composed of other materials as long as the pattern has a certain degree of transparency to the irradiation light, and the pattern does not necessarily need to be transparent to visible light. The pattern is not limited to a transparent electrode, and may be patterns for other applications. However, the image acquisition apparatus is particularly suitable for display of a transparent electrode on which no shadow is cast even when the electrode is irradiated with visible light.

The moving mechanism for moving the base material relative to the image capturing region may be a mechanism for fixing the base material and moving the imaging unit 32. The light irradiation part-turning mechanism 322 and the light receiving part-turning mechanism 324 do not necessarily need to be independent from each other, and may be a mechanism for linking and changing the irradiation angle and the detection angle. In the light irradiation part-turning mechanism 322 and the light receiving part-turning mechanism 324, the irradiation angle and the detection angle do not necessarily need to be changed in a continuous manner, and for example, they may be changed in only several steps (the same applies to the sliding part-moving mechanism 344 in FIG. 42 and the roller up-and-down mechanism 346 in FIG. 43).

The wavelength of the light emitted from the light irradiation part is not limited to a single wavelength, and light of a plurality of wavelengths may be emitted selectively. The light source may include an LD, instead of an LED. Furthermore, a combination of a lamp, such as a halogen lamp, and filters may be provided as the light source. The film thickness measurement part 312 may be a spectral ellipsometer.

The configurations of the above-described embodiments and variations may be appropriately combined as long as there are no mutual inconsistencies.

While the invention has been shown and described in detail, the foregoing description is in all aspects illustrative and not restrictive. It is therefore understood that numerous modifications and variations can be devised without departing from the scope of the invention. This application claims priority benefit under 35 U.S.C. Section 119 of Japanese Patent Application No. 2011-123071 filed in the Japan Patent Office on Jun. 1, 2011, Japanese Patent Application No. 2011-205886 filed in the Japan Patent Office on Sep. 21, 2011, and Japanese Patent Application No. 2011-213759 filed in the Japan Patent Office on Sep. 29, 2011, the entire disclosures of which are incorporated herein by reference.

### REFERENCE SIGNS LIST

11, 11a Pattern inspection apparatus
19, 29a, 39a Web
19a, 29, 39 Glass substrate
21, 21a Pattern-image display apparatus
31, 31a-31c Image acquisition apparatus
32 Imaging unit
110, 110a Inspection-image acquisition apparatus
111, 111a, 211a, 311a Conveying mechanism
112, 212, 312 Film thickness measurement part
131, 231, 331 Profile acquisition part
132, 232, 332 Angle determination part
134, 336 Inspection part
190, 290, 390 Image capturing region
211, 311 Moving mechanism
214 Auxiliary imaging part
130, 230, 330 Overall control part
234, 334 Display
235 Input receiving part
321, 321a, 1131, 2131, 2131a Light irradiation part
322 Light irradiation part-turning mechanism
323 Light receiving part
324 Light receiving part-turning mechanism
325 Light receiving part-moving mechanism
344 Sliding part-moving mechanism
346 Roller up-and-down mechanism
1132, 2132, 3231 Line sensor
1133, 2133, 2133a Angle change mechanism
1136, 2136 Polarizer
1137, 2137 Rotation mechanism
1331 Inspection image data
3232 Optical system
J1, J2 Optical axis
N Normal line
P Focus position
S113-S115, S213, S214, S216, S217, S315, S3141, S3144, S3146 Step
α Angle range
γ Amount of change
θ1 Irradiation angle
θ2 Detection angle

1. An image acquisition apparatus for acquiring an image of a thin film pattern formed on a base material, comprising:
a light irradiation part that emits light of a wavelength having a property of passing through said thin film pattern;
a line sensor that receives reflected light from a line-shaped image capturing region irradiated with said light;
a moving mechanism for moving said base material relative to said image capturing region in a direction intersecting said image capturing region; and
an angle change mechanism for changing an irradiation angle and a detection angle while keeping said irradiation angle and said detection angle equal to each other, said irradiation angle being an angle formed by an optical axis from said light irradiation part to said image capturing region and a normal line of said base material, and said detection angle being an angle formed by said normal line and an optical axis from said image capturing region to said line sensor.

2. The image acquisition apparatus according to claim 1, further comprising:
a profile acquisition part that acquires a profile indicating a relationship between said irradiation angle and detection angle and a contrast between said thin film pattern and a background; and
an angle determination part that obtains a set angle for said irradiation angle and said detection angle, from said profile.

3. The image acquisition apparatus according to claim 2, wherein
said profile acquisition part obtains said profile based on a layer structure on said base material and a film thickness of each layer.

4. The image acquisition apparatus according to claim 3, further comprising:
a film thickness measurement part that obtains said film thickness of each layer,
wherein said profile acquisition part obtains said profile based on output from said film thickness measurement part.

5. The image acquisition apparatus according to claim 1, further comprising:
a polarizer disposed between said image capturing region and said line sensor.

6. The image acquisition apparatus according to claim 2, further comprising:
a polarizer disposed between said image capturing region and said line sensor; and
a polarization switching mechanism for changing a direction of polarization by said polarizer,
wherein said profile acquisition part acquires a first profile and a second profile as said profile, said first profile indicating a first contrast obtained with p-polarized light between said thin film pattern and said background, and said second profile indicating a second contrast obtained with s-polarized light between said thin film pattern and said background,
said angle determination part obtains said set angle using a product of said first contrast and said second contrast, and
said line sensor acquires a first image obtained with the p-polarized light and a second image obtained with the s-polarized light as said image.

7. The image acquisition apparatus according to claim 1, wherein
said thin film pattern has a film thickness that is greater than or equal to 10 nm and less than or equal to 2000 nm.

8. The image acquisition apparatus according to claim 1, further comprising:
a display part that displays the image of said thin film pattern based on output from said line sensor.

9. The image acquisition apparatus according to claim 8, further comprising:
a profile acquisition part that acquires a profile indicating a relationship between said irradiation angle and detection angle and a contrast between said thin film pattern and a background; and
an angle determination part that obtains a set angle for said irradiation angle and said detection angle, from said profile.

10. The image acquisition apparatus according to claim 8, further comprising:
an input receiving part that receives input of a display target position on said base material; and
a control part that causes said moving mechanism to move said base material relative to said image capturing region such that said display target position passes through said image capturing region.

11. The image acquisition apparatus according to claim 8, further comprising:
an auxiliary imaging part in which a plurality of light receiving elements are arranged in a two-dimensional array and that acquires an auxiliary image of said base material; and
a control part that controls said moving mechanism,
wherein said auxiliary image is displayed on said display part, and
said control part causes said moving mechanism to move said base material relative to said image capturing region such that a position indicated on said base material by said auxiliary image passes through said image capturing region.

12. The image acquisition apparatus according to claim 1, further comprising:
a control part,
wherein said line sensor is provided in a light receiving part,
said light receiving part further includes an optical system that guides the reflected light from said image capturing region to said line sensor,
said angle change mechanism includes:
a detection-angle change mechanism for changing said detection angle that is an angle formed by an optical axis of said optical system and said normal line of said base material, and
a light receiving part-moving mechanism for moving said light receiving part along said optical axis of said optical system,
said light irradiation part, said light receiving part, and said angle change mechanism are provided in an imaging unit that captures an image of said image capturing region, and
said control part causes a conjugate position of said optical axis of said optical system that has a conjugate relationship with a light receiving surface of said line sensor, to be disposed on said thin film pattern by controlling said light receiving part-moving mechanism based on an amount of change in said detection angle.

13. The image acquisition apparatus according to claim 12, wherein
said imaging unit further includes a light irradiation part-turning mechanism for turning said light irradiation part around an axis that is parallel to said image capturing region and that passes through said conjugate position,
said light irradiation part-turning mechanism is fixed to said light receiving part, and
said control part causes said irradiation angle to be equal to said detection angle by controlling said light irradiation part-turning mechanism based on the amount of change in said detection angle.

14. The image acquisition apparatus according to claim 12, wherein
said light irradiation part is configured to irradiate said image capturing region with said light in a predetermined angle range centered on an axis that is parallel to said image capturing region and that passes through said conjugate position,
said light irradiation part is fixed to said light receiving part, and
on a plane that is perpendicular to said axis, an angular position that is inclined at said detection angle from said normal line on a side opposite said optical axis of said optical system, with said axis as the center, is included in said predetermined angle range.

15. The image acquisition apparatus according to claim 12, wherein
said control part causes positions of said image capturing region relative to said base material before and after change of said detection angle to match by controlling said moving mechanism based on the amount of change in said detection angle.

16. The image acquisition apparatus according to claim 12, further comprising:
another imaging unit having the same configuration as said imaging unit.

17. A pattern inspection apparatus for inspecting a thin film pattern formed on a base material, comprising:
an image acquisition apparatus; and
an inspection part that executes inspection of said thin film pattern based on an image acquired by said image acquisition apparatus,
said image acquisition apparatus including:
a light irradiation part that emits light of a wavelength having a property of passing through said thin film pattern;
a line sensor that receives reflected light from a line-shaped image capturing region irradiated with said light;
a moving mechanism for moving said base material relative to said image capturing region in a direction intersecting said image capturing region; and
an angle change mechanism for changing an irradiation angle and a detection angle while keeping said irradiation angle and said detection angle equal to each other, said irradiation angle being an angle formed by an optical axis from said light irradiation part to said image capturing region and a normal line of said base material, and said detection angle being an angle formed by said normal line and an optical axis from said image capturing region to said line sensor.

18. An image acquisition method for acquiring an image of a thin film pattern formed on a base material, comprising the steps of:
a) obtaining a set angle for an irradiation angle that is formed by an optical axis from a light irradiation part to a line-shaped image capturing region and a normal line of said base material, said light irradiation part emitting light of a wavelength having a property of passing through said thin film pattern;
b) setting said irradiation angle to said set angle and setting a detection angle also to said set angle, said detection angle being an angle formed by said normal line and an optical axis from said image capturing region to a line sensor; and
c) moving said base material relative to said image capturing region in a direction intersecting said image capturing region.

19. The image acquisition method according to claim 18, further comprising the step of:
d) displaying the image of said thin film pattern on a display part based on output from said line sensor,
said step d) being performed after said step c).

20. The image acquisition method according to claim 18, wherein
said image is acquired by an image acquisition apparatus,
said image acquisition apparatus including:
said light irradiation part; and
a light receiving part that includes said line sensor and an optical system that guides light from said image capturing region to said line sensor, and
said step b) includes the steps of:
b1) changing said detection angle that is an angle formed by an optical axis of said optical system and said normal line of said base material; and
b2) causing a conjugate position of said optical axis of said optical system that has a conjugate relationship with a light receiving surface of said line sensor, to be disposed on said thin film pattern by moving said light receiving part along said optical axis of said optical system.

21. The image acquisition method according to claim 20, wherein
said step b) further includes the step of:
b3) causing positions of said image capturing region relative to said base material before and after change of said detection angle to match by moving said base material relative to said image capturing region.
